(19) United States
(12) Patent Application Publication
(10) Pub. No.: US 2019/0045198 A1
(43) Pub. Date: Feb. 7, 2019

(54) REGION ADAPTIVE DATA-EFFICIENT GENERATION OF PARTITIONING AND MODE DECISIONS FOR VIDEO ENCODING

(71) Applicant: Intel Corporation, Santa Clara, CA (US)

(72) Inventors: Nader MAHDI, Maple Ridge (CA); Chekib NOUIRA, Vancouver (CA); Hassen GUERMAZI, Vancouver (CA); Faouzi KOSSENTINI, Vancouver (CA)

(73) Assignee: Intel Corporation, Santa Clara, CA (US)

(21) Appl. No.: 15/856,691

(22) Filed: Dec. 28, 2017

(51) Int. Cl. H04N 19/186

(52) U.S. Cl. CPC H04N 19/186; H04N 19/176

(57) ABSTRACT

Techniques related to detection of features and modification of encoding based on such detected features for improved data utilization efficiency are discussed. Such techniques include generating a partitioning decision for a block and coding mode decisions for partitions of the individual block using the detected features or indicators thereof based on one or more of generating a luma and chroma or luma only evaluation decision for a partition, generating a merge or skip mode decision for a partition having an initial merge mode decision, generating only a portion of a transform coefficient block for a partition, and evaluating 4×4 partitions only for any partition of the partitions that are 8×8 initial coding partitions.

### BACKGROUND

In compression/decompression (codec) systems, compression efficiency, data utilization efficiency, and video quality are important performance criteria. Visual quality is an important aspect of the user experience in many video applications and compression efficiency, which is impacted by data utilization efficiency, impacts the amount of memory storage needed to store video files and/or the amount of bandwidth needed to transmit and/or stream video content. For example, a video encoder compresses video information so that more information can be sent over a given bandwidth or stored in a given memory space or the like. The compressed signal or data may then be decoded via a decoder that decodes or decompresses the signal or data for display to a user. In most implementations, higher visual quality with greater compression is desirable. Furthermore, encoding speed and efficiency are important aspects of video encoding.

It may be advantageous to improve data utilization efficiency and compression rate through data utilization efficiency while maintaining or even improving video quality. It is with respect to these and other considerations that the present improvements have been needed. Such improvements may become critical as the desire to compress and transmit video data becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example system for providing video coding;

FIG. 2 illustrates an example group of pictures;

FIG. 3 illustrates an example video picture;

FIG. 4 is an illustrative diagram of an example partitioning and mode decision module for providing LCU partitions and intra/inter modes data;

FIG. 5 is an illustrative diagram of an example encoder for generating a bitstream;

FIG. 6 illustrates a block diagram of an example integrated encoding system;

FIG. 7 is a flow diagram illustrating an example process for selectively using chroma information in partitioning and coding mode decisions;

FIG. 8 is a flow diagram illustrating an example process for generating a merge or skip mode decision for a partition having an initial merge mode decision;

FIG. 9 is a flow diagram illustrating an example process for determining a partitioning decision and coding mode decisions for a block by generating only a portion of a transform coefficient block for a partition of the block;

FIG. 10 illustrates an example data structure corresponding to an example partial transform;

FIG. 11 illustrates an example data structure corresponding to another example partial transform;

FIG. 12 is a flow diagram illustrating an example process for determining a partitioning decision and coding mode decisions for a block by generating only a portion of a transform coefficient block for a partition of the block based on whether the partition is in a visually important area;

FIG. 13 is a flow diagram illustrating an example process for determining a partitioning decision and coding mode decisions for a block by generating only a portion of a transform coefficient block for a partition of the block based on edge detection in the block;

FIG. 14 is a flow diagram illustrating an example process for selectively evaluating 4×4 partitions in video coding;

FIG. 15 is an illustrative diagram of an example flat and noisy region detector;

FIG. 16 is a flow diagram illustrating an example process for video encoding;

FIG. 17 is an illustrative diagram of an example system for video encoding;

FIG. 18 is an illustrative diagram of an example system; and

FIG. 19 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Methods, devices, apparatuses, computing platforms, and articles are described herein related to video coding and, in particular, to implementing detectors of video characteristics to modify video encoding for improved efficiency.

Techniques discussed herein provide for improved data utilization efficiency by modifying encode operations based on detected features of a region of a picture. As used herein, the term region may include any of a block of a picture, a coding unit of a picture, a largest coding unit of a picture, a region including multiple contiguous blocks of a picture, a partition of a block or coding unit, a slice of a picture, or the picture itself. Furthermore, the term partition may indicate a partition for coding or a partition for transform. The detected features, which may be indicated by detection indicators, may include any features discussed herein such as a luma average of a region (i.e., the average of luma values for a region), a chroma channel average of a region (i.e., the average of chroma values for a particular chroma channel), and/or a second chroma channel average of a region (i.e., the average of chroma values for another particular chroma channel), indicators of the result of comparison of such values to thresholds (e.g., whether the average exceeds a threshold), the temporal level of the region (e.g., whether the region is in an I-slice, base layer B-slice, non-base layer B-slice, etc.), a magnitude of a difference between an initial skip mode coding cost and an initial merge mode coding cost for a region, an indicator of whether a region includes an edge, an indicator of the strength of such an edge, an indicator of whether a region is in an uncovered area or is an uncovered region, an initial best intra mode of a region, or others as discussed herein.

Such detected features or detection indicators are then used to modify encoding as is discussed further herein. Such coding modifications may include evaluation of luma only vs. evaluation of luma and chroma for partitioning decisions and/or coding modes for a block, use of luma and chroma for only merge or skip mode decisions, use of initial merge or skip mode decisions without further evaluation at an encode pass, generation of only portions of transform coefficient blocks in local decode loop (i.e., not generating full transform coefficient blocks in some instances for improved efficiency), evaluation of 4×4 intra modes in addition to evaluation of 8×8 coding modes, and others as discussed herein.

The discussed detected features or detection indicators may be generated using original video content (e.g., without use of local decode loop reconstructed pixels) and may be implemented in the context of a decoupled video encoder that decouples the generation of final partitioning decision and associated initial coding mode decisions based on use of only source samples from a full standards compliant encoding with compliant local decode loop or in the context of an integrated encoder that generates partition and coding mode decisions using reconstructed samples from a local decode loop. As used herein, the term sample or pixel sample may be any suitable pixel value. The term original pixel sample is used to indicate samples or values from input video and to contrast with reconstructed pixel samples, which are not original pixel samples but are instead reconstructed after encode and decode operations in a standards compliant encoder.

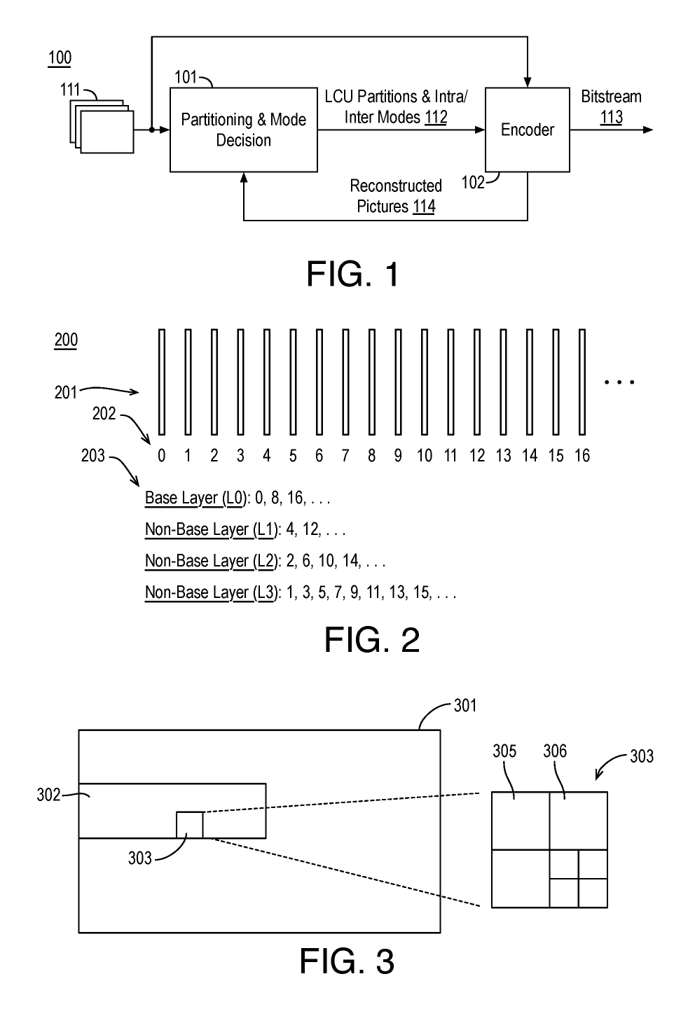

FIG. 1 is an illustrative diagram of an example system 100 for providing video coding, arranged in accordance with at least some implementations of the present disclosure. As shown in FIG. 1, system 100 includes a partitioning and mode decision module 101 and an encoder 102. As shown, partitioning and mode decision module 101, which may be characterized as a partitioning, motion estimation, and mode decision module or the like, receives input video 111 and, optionally, reconstructed pictures 114, and partitioning and mode decision module 101 generates largest coding unit (LCU) partitions and corresponding coding modes (intra/inter modes) data 112. For example, for each LCU of each picture of input video 111, partitioning and mode decision module 101 provides a partition decision (i.e., data indicative of how the LCU is to be partitioned into coding units/prediction units/transform units (CU/PU/TU), a coding mode for each CU (i.e., an inter mode, an intra mode, or the like), and information, if needed, for the coding mode (i.e., a motion vector for inter coding). As used herein, the term partition is used to indicate any sub-block or sub-region of a block such as a partition for coding or a partition for transform or the like. For example, in the context of a block being a largest coding unit, a partition may be a coding unit (e.g., CU) or a transform unit (e.g., TU). A transform unit may be the same size or smaller than a coding unit.

As shown, encoder 102 receives LCU partitions and intra/inter modes data 112 and encoder 102 generates a bitstream 113 such as a standards compliant bitstream and reconstructed pictures 114. For example, encoder 102 implements LCU partitions and intra/inter modes data 112. In decoupled encoder embodiments, encoder 102 implements final decisions made by partitioning and mode decision module 101, optionally adjusts any initial mode decisions made by partitioning and mode decision module 101, and implements such partitioning and mode decisions to generate a standards compliant bitstream 113. In such embodiments, reconstructed pictures 114 may be generated to serve as reference pictures in encoder 102 but such reconstructed pictures 114 are not used in partitioning and mode decision module 101. In integrated encoder implementations, encoder 102 implements decisions made by partitioning and mode decision module 101 and implements such partitioning and mode decisions to generate a standards compliant bitstream 113 and reconstructed pictures 114. Such reconstructed pictures 114 are used in the generation of partitioning decisions and mode decisions for subsequent LCUs of input video 111.

As shown, system 100 receives input video 111 for coding and system provides video compression to generate bitstream 113 such that system 100 may be a video encoder implemented via a computer or computing device or the like. Bitstream 113 may be any suitable bitstream such as a standards compliant bitstream. For example, bitstream 113 may be H.264/MPEG-4 Advanced Video Coding (AVC) standards compliant, H.265 High Efficiency Video Coding (HEVC) standards compliant, VP9 standards compliant, etc. System 100 may be implemented via any suitable device such as, for example, a personal computer, a laptop computer, a tablet, a phablet, a smart phone, a digital camera, a gaming console, a wearable device, an all-in-one device, a two-in-one device, or the like or a platform such as a mobile platform or the like. For example, as used herein, a system, device, computer, or computing device may include any such device or platform.

Input video 111 may include any suitable video frames, video pictures, sequence of video frames, group of pictures, groups of pictures, video data, or the like in any suitable resolution. For example, the video may be video graphics array (VGA), high definition (HD), Full-HD (e.g., 1080p), 4K resolution video, 8K resolution video, or the like, and the video may include any number of video frames, sequences of video frames, pictures, groups of pictures, or the like. Techniques discussed herein are discussed with respect to pictures and blocks and/or coding units for the sake of clarity of presentation. However, such pictures may be characterized as frames, video frames, sequences of frames, video sequences, or the like, and such blocks and/or coding units may be characterized as coding blocks, macroblocks, sub-units, sub-blocks, regions, sub-regions, etc. Typically, the terms block and coding unit are used interchangeably herein. For example, a picture or frame of color video data may include a luma plane or component (i.e., luma pixel values) and two chroma planes or components (i.e., chroma pixel values) at the same or different resolutions with respect to the luma plane. Input video 111 may include pictures or frames that may be divided into blocks and/or coding units of any size, which contain data corresponding to, for example, M×N blocks and/or coding units of pixels. Such blocks and/or coding units may include data from one or more planes or color channels of pixel data. As used herein, the term block may include macroblocks, coding units, or the like of any suitable sizes. As will be appreciated such blocks may also be divided into sub-blocks for prediction, transform, etc.

FIG. 2 illustrates an example group of pictures 200, arranged in accordance with at least some implementations of the present disclosure. As shown in FIG. 2, group of pictures 200 may include any number of pictures 201 such as 64 pictures (with 0-16 being illustrated) or the like. Furthermore, pictures 201 may be provided in a temporal order 202 such that pictures 201 are presented in temporal order while pictures 201 are coded in a coding order (not shown) such that the coding order is different with respect to temporal order 202. Furthermore, pictures 201 may be provided in a picture hierarchy 203 such that a base layer (L0) of pictures 201 includes pictures 0, 8, 16, and so on; a non-base layer (L1) of pictures 201 includes pictures 4, 12, and so on; a non-base layer (L2) of pictures 201 includes pictures 2, 6, 10, 14, and so on; and a non-base layer (L3) of pictures 201 includes pictures 1, 3, 5, 7, 9, 11, 13, 15, and so on. For example, moving through the hierarchy, for inter modes, pictures of L0 may only reference other pictures of L0, pictures of L1 may only reference pictures of L0, pictures of L2 may only reference pictures of L0 or L1, and pictures of L3 may reference pictures of any of L0-L2. For example, pictures 201 include base layer pictures and non-base layer pictures such that base layer pictures are reference pictures for non-base layer pictures but non-base layer pictures are not reference pictures for base layer pictures as shown. In an embodiment, input video 111 includes group of pictures 200 and/or system 100 implements group of pictures 200 with respect to input video 111. Although illustrated with respect to an example, group of pictures 200, input video 111 may have any suitable structure implementing group of pictures 200, another group of pictures format, etc. In an embodiment, a prediction structure for coding video includes groups of pictures such as group of pictures 200. For example, in the context of broadcast and streaming implementations, the prediction structure may be periodic and may include periodic groups of pictures (GOPs). In an embodiment, a GOP includes about 1-second of pictures organized in the structure described in FIG. 2, followed by another GOP that starts with an I picture, and so on.

FIG. 3 illustrates an example video picture 301, arranged in accordance with at least some implementations of the present disclosure. Video picture 301 may include any picture of a video sequence or clip such as a VGA, HD, Full-HD, 4K, 8K, etc. video picture. For example, video picture 301 may be any of pictures 201. As shown, video picture 301 may be segmented or partitioned into one or more slices as illustrated with respect to slice 302 of video picture 301. Furthermore, video picture 301 may be segmented or partitioned into one or more LCUs as illustrated with respect to LCU 303, which may, in turn, be segmented into one or more coding units as illustrated with respect to CUs 305, 306 and/or prediction units (PUs) and transform units (TUs), not shown. As used herein, the term partition may refer to a CU, a PU, or a TU. Although illustrated with respect to slice 302, LCU 303, and CUs 305, 306, which corresponds to HEVC coding, the techniques discussed herein may be implemented in any coding context. As used herein, a region may include any of a slice, LCU, CU, picture, or other area of a picture.

Furthermore, as used herein, a partition includes a portion of a block or region or the like. For example, in the context of HEVC, a CU is a partition of an LCU. However, a partition may be any sub-region of a region, sub-block of a block, etc. The terminology corresponding to HEVC is used herein for the sake of clarity of presentation but is not meant to be limiting.

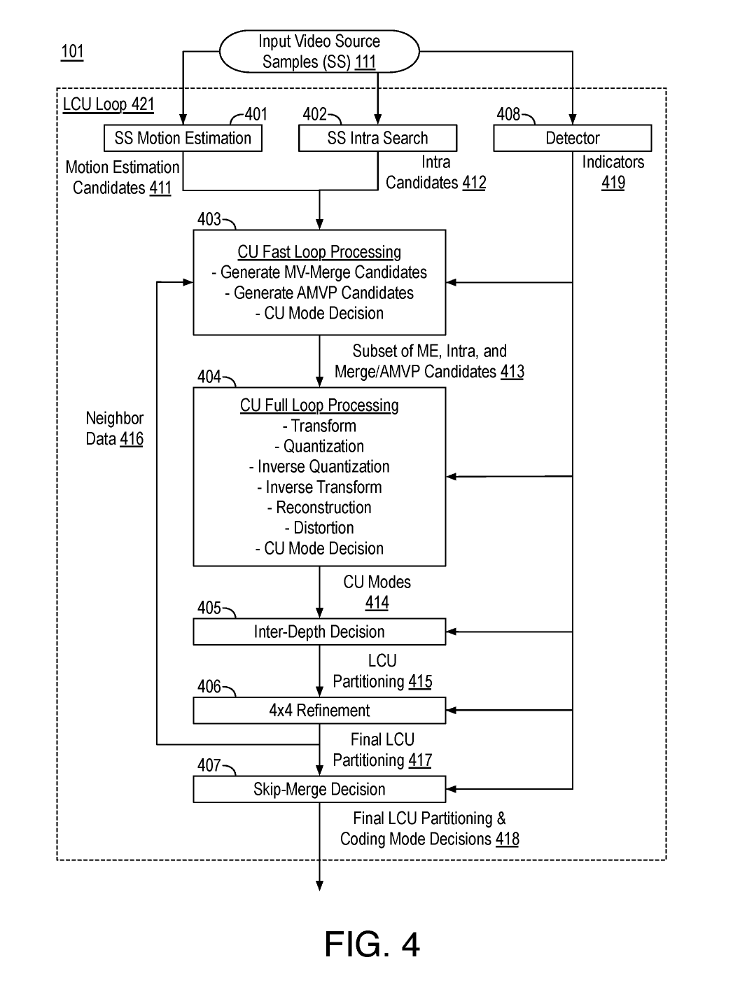

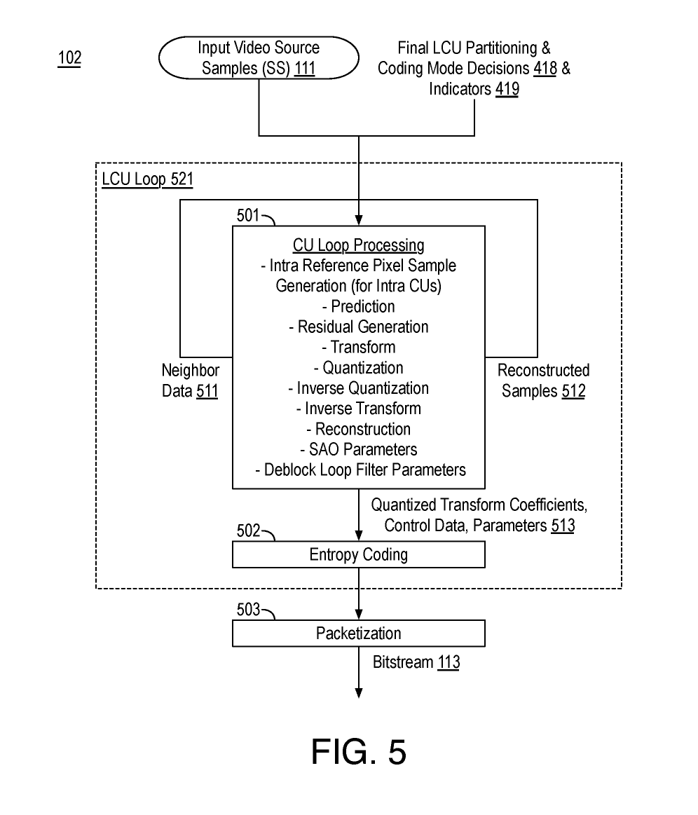

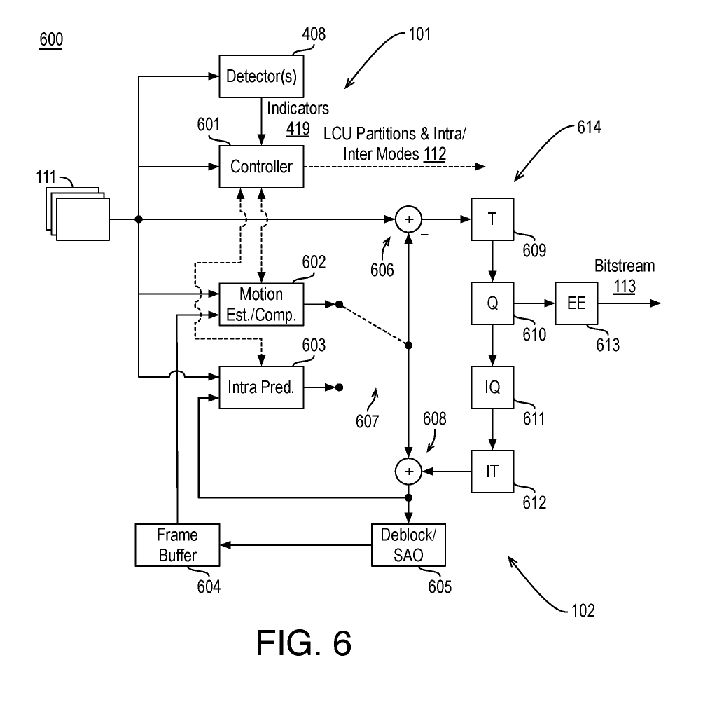

FIG. 4 is an illustrative diagram of an example partitioning and mode decision module 101 for providing LCU partitions and intra/inter modes data 112, arranged in accordance with at least some implementations of the present disclosure. For example, FIGS. 4 and 5 illustrate an example decoupled encoder embodiment while FIG. 6 illustrates an example integrated encoder embodiment. Either embodiment may be used in the implementation of the techniques discussed herein.

As shown in FIG. 4, partitioning and mode decision module 101 may include or implement an LCU loop 421 that includes a source samples (SS) motion estimation module 401, an SS intra search module 402, a CU fast loop processing module 403, a CU full loop processing module 404, an inter-depth decision module 405, an intra/inter 4×4 refinement module 406, and a skip-merge decision module 407. As shown, LCU loop 421 receives input video 111 and LCU loop 421 generates final LCU partitioning and initial mode decisions data 418. Final LCU partitioning and initial mode decisions data 418 may be any suitable data that indicates or describes partitioning for the LCU into CUs and a coding mode decision for each CU of the LCU. In an embodiment, final LCU partitioning and initial mode decisions data 418 includes final partitioning data that will be implemented without modification by encoder 102 and initial mode decisions that may be modified. For example, the coding mode decisions may include an intra mode (i.e., one of the available intra modes based on the standard being implemented) or an inter mode (i.e., skip, merge, or motion estimation, ME). Furthermore, LCU partitioning and mode decisions data 418 may include any additional data needed for the particular mode (e.g., a motion vector for an inter mode). For example, in the context of HEVC, a coding tree unit may be 64×64 pixels, which may define an LCU. An LCU may be partitioned for coding into CUs via quad-tree partitioning such that the CUs may be 32×32, 16×16 pixels, or 8×8 pixels. Such partitioning may be indicated by LCU partitioning and mode decisions data 418. Furthermore, such partitioning is used to evaluate candidate partitions (candidate CUs) of an LCU.

As shown, SS motion estimation module 401 receives input video 111 and SS motion estimation module 401 performs a motion search for CUs or candidate partitions of a current picture of input video 111 using one or more reference pictures of input video 111 such that the reference pictures include only original pixel samples of input video 111. As shown, SS motion estimation module 401 generates motion estimation candidates 411 (i.e., MVs) corresponding to CUs of a particular partitioning of a current LCU under evaluation. For example, for each CU, one or more MVs may be provided. Furthermore, SS intra search module 402 receives input video 111 and SS intra search module 402 generates intra modes for CUs of a current picture of input video 111 using the current picture of input video 111 by comparing the CU to an intra prediction block generated (based on the current intra mode being evaluated) using original pixel samples of the current picture input video 111. As shown, SS intra search module 402 generates intra candidates 412 (i.e., selected intra modes) corresponding to CUs of a particular partitioning of a current LCU under evaluation. For example, for each CU, one or more intra candidates may be provided. In an embodiment, a best partitioning decision and corresponding best intra and/or inter candidates (e.g., having a lowest distortion or lowest rate distortion cost or the like) from motion estimation candidates 411 and intra candidates 412 are provided for use by encoder 102 as discussed herein. For example, subsequent processing may be skipped.

Furthermore, detector module 408 receives input video 111 and/or data from SS motion estimation module 401 and/or SS intra search module 402. Detector module 408 applies one or more detectors to input video 111 and or such received data and detector module 408 generates and provides detection indicators 419 for use by other modules of partitioning and mode decision module 101 and/or encoder 102 as discussed with respect to FIG. 5.

CU fast loop processing module 403 receives motion estimation candidates 411, intra candidates 412, detection indicators 419, and neighbor data 416 and, as shown, generates MV-merge candidates, generates advanced motion vector prediction (AMVP) candidates, and makes a CU mode decision. Neighbor data 416 includes any suitable data for spatially neighboring CUs of the current CUs being evaluated such as intra and/or inter modes of the spatial neighbors. CU fast loop processing module 403 generates MV-merge candidates using any suitable technique or techniques. For example, merge mode may provide motion inference candidates using MVs from spatially neighboring CUs of a current CU. For example, one or more MVs from spatially neighboring CUs may be provided (e.g., inherited) as MV candidates for the current CU. Furthermore, CU fast loop processing module 403 generates AMVP candidates using any suitable technique or techniques. In an embodiment, CU fast loop processing module 403 may use data from a reference picture and data from neighboring CUs to generate AMVP candidate MVs. Furthermore, in generating MV-merge and/or AMVP candidates, non-standards compliant techniques may be used. Predictions for the MV-merge and AMVP candidates are generated using only source samples.

As shown, CU fast loop processing module 403 makes a coding mode decision for each CU for the current partitioning based on motion estimation candidates 411, intra candidates 412, MV-merge candidates, and AMVP candidates. The coding mode decision may be made using any suitable technique or techniques. In an embodiment, a sum of a distortion measurement and a weighted rate estimate is used to evaluate the intra and inter modes for the CUs. For example, a distortion between the current CU and prediction CUs (generated using the corresponding mode) may be determined and combined with an estimated coding rate to determine the best candidates. As shown, a subset of the ME, intra, and merge/AMVP candidates 413 may be generated as a subset of all available candidates.

Subset of the ME, intra, and merge/AMVP candidates 413 is provided to CU full loop processing module 404. A shown, CU full loop processing module 404 performs, for a residual block for each coding mode of subset of the ME, intra, and merge/AMVP candidates 413 (i.e., the residual being a difference between the CU and the prediction CU generated using the current mode), forward transform, forward quantization, inverse quantization, and inverse transform to form a reconstructed residual. Then, CU full loop processing module 404 generates a reconstruction of the CU (i.e., by adding the reconstructed residual to the prediction CU) and measures distortion for each mode of subset of the ME, intra, and merge/AMVP candidates 413. The mode with optimal rate distortion is selected as CU modes 414.

CU modes 414 are provided to inter-depth decision module 405, which may evaluate the available partitions of the current LCU to generate LCU partitioning data 415. As shown, LCU partitioning data 415 is provided to intra/inter 4×4 refinement module 406, which may evaluate 4×4 partitions using intra and/or inter modes. For example, prior processing evaluates partitioning down to a coding unit size of 8×8 and intra/inter 4×4 refinement module 406 evaluates 4×4 partitioning and intra and/or inter modes for such 4×4 partitions in various contexts. As shown, intra/inter 4×4 refinement module 406 provides final LCU partitioning data 417 to skip-merge decision module 407, which, for any CUs that have a coding mode corresponding to a merge MV, determines whether the CU is a skip CU or a merge CU. For example, for a merge CU, the MV is inherited from a spatially neighboring CU and a residual is sent for the CU. For a skip CU, the MV is inherited from a spatially neighboring CU (as in merge mode) but no residual is sent for the CU. As shown, after such merge-skip decisions, LCU loop 421 provides final LCU partitioning and initial mode decisions data 418.

FIG. 5 is an illustrative diagram of an example encoder 102 for generating bitstream 113, arranged in accordance with at least some implementations of the present disclosure. As shown in FIG. 5, encoder 102 may include or implement an LCU loop 521 (e.g., an LCU loop for an encode pass) that includes a CU loop processing module 501 and an entropy coding module 502. Also as shown, encoder 102 may include a packetization module 503. As shown, LCU loop 521 receives input video 111 and final LCU partitioning and initial mode decisions data 418 and LCU loop 521 generates quantized transform coefficients, control data, and parameters 513, which may be entropy encoded by entropy coding module 502 and packetized by packetization module 503 to generate bitstream 113.

For example, CU loop processing module 501 receives input video 111, final LCU partitioning and initial mode decisions data 418, and detection indicators 419. Based on final LCU partitioning and initial mode decisions data 418, CU loop processing module 501, as shown, generates intra reference pixel samples for intra CUs (as needed). For example, intra reference pixel samples may be generated using neighboring reconstructed pixel samples (generated via a local decode loop). As shown, for each CU, CU loop processing module 501 generates a prediction CU using neighbor data 511 (e.g., data from neighbors of the current CU), as needed. For example, the prediction CU may be generated for inter modes by retrieving previously reconstructed pixel samples for a CU indicated by a MV or MVs from a reconstructed reference picture or pictures and, if needed, combining the retrieved reconstructed pixel samples to generate the prediction CU. For intra modes, the prediction CU may be generated using the neighboring reconstructed pixel samples from the picture of the CU based on the intra mode of the current CU. As shown, a residual is generated for the current CU. For example, the residual may be generated by differencing the current CU and the prediction CU.

The residual is then forward transformed and forward quantized to generate quantized transform coefficients, which are included in quantized transform coefficients, control data, and parameters 513. Furthermore, in a local decode loop, for example, the transform coefficients are inverse quantized and inverse transformed to generate a reconstructed residual for the current CU. As shown, CU loop processing module 501 performs a reconstruction for the current CU by, for example, adding the reconstructed residual and the prediction CU (as discussed above) to generate a reconstructed CU. The reconstructed CU may be combined with other CUs to reconstruct the current picture or portions thereof using additional techniques such as sample adaptive offset (SAO) filtering, which may include generating SAO parameters (which are included in quantized transform coefficients, control data, and parameters 513) and implementing the SAO filter on reconstructed CUs and/or deblock loop filtering (DLF), which may include generating DLF parameters (which are included in quantized transform coefficients, control data, and parameters 513) and implementing the DLF filter on reconstructed CUs. Such reconstructed CUs may be provided as reference pictures (e.g., stored in a reconstructed picture buffer) for example. Such reference pictures or portions thereof are provided as reconstructed samples 512, which are used for the generation of prediction CUs (in inter and intra modes) as discussed above.

As shown, quantized transform coefficients, control data, and parameters 513, which include transform coefficients for residual coding units, control data such as final LCU partitioning and mode decisions data (i.e., from final LCU partitioning and initial mode decisions data 418), and parameters such as SAO/DLF filter parameters, may be entropy encoded and packetized to form bitstream 113. Bitstream 113 may be any suitable bitstream such as a standards compliant bitstream. For example, bitstream 113 may be H.264/MPEG-4 Advanced Video Coding (AVC) standards compliant, H.265 High Efficiency Video Coding (HEVC) standards compliant, VP9 standards compliant, etc.

FIG. 6 illustrates a block diagram of an example integrated encoding system 600, arranged in accordance with at least some implementations of the present disclosure. As discussed, encoding system 600 provides an integrated encoder implementation such that LCU partitions and intra/inter modes data 112 may be determined using detection indicators 419 and evaluation of partitions and coding modes using reconstructed pixel data. For example, encoding system 600 may implement system 100 discussed herein. As shown, encoding system 600 may include detector module 408, a controller 601, a motion estimation and compensation module 602, an intra prediction module 603, a deblock filtering (Deblock) and sample adaptive offset (SAO) module 605, a selection switch 607, a differencer 606, an adder 608, a transform (T) module 609, a quantization (Q) module 610, an inverse quantization (IQ) module 611, an inverse transform (IT) module 612, an entropy encoder (EE) module 613, and a picture buffer 604 for storing reconstructed pictures 114. Encoding system 600 may include additional modules and/or interconnections that are not shown for the sake of clarity of presentation.

As shown, encoding system 600 receives input video 111 and encoding system 600 generates bitstream 113, which may have any characteristics as discussed herein. For example, encoding system 600 divides pictures of input video 111 into LCUs, which are in turn partitioned into candidate partitions. After evaluation of such candidate partitions, a partitioning decision for the LCU and coding mode decisions for partitions of the individual block corresponding to the partitioning decision are generated by controller 601 as LCU partitions and intra/inter modes data 112, which are provided to other components of encoding system 600 for encoding of the LCU and inclusion in bitstream 113. As shown, detection indicators 419 are used in the generation of LCU partitions and intra/inter modes data 112 and bitstream 113 for improved efficiency as discussed herein below.

With continued reference to FIG. 6, encoding system 600 may perform an LCU loop in analogy with LCU loop 421 via motion estimation and compensation module 602 receiving input video 111 and reconstructed pictures 114 (not shown in FIG. 6) and performing a motion estimation for candidate CUs or partitions of a current LCU of a picture of input video 111 using one or more reference pictures of reconstructed pictures 114 such that the reference pictures include reconstructed pixel samples (e.g., after a local decode loop 614 is applied) such that motion estimation and compensation module 602 and controller 601 generates in analogy to motion estimation candidates 411. Furthermore, intra prediction module 603 receives input video 111 and reconstructed pixel samples post-adder 608 and intra prediction module 603 and controller 601 generate intra modes for CUs of a current picture of input video 111 using the current picture of input video 111 by comparing the CU to an intra prediction block generated using reconstructed pixel samples (e.g., after local decode loop 614 is applied). Controller 601 then generates an LCU partition decision (e.g., defining partitioning of an LCU) and corresponding mode decision for each partition (e.g., one of an inter or intra mode for each partition) for encoding the LCU. For example, for each partition (e.g., CU) of a block (e.g., LCU), controller 601 may, via LCU partitions and intra/inter modes data 112, control selection switch 607 to generate a predicted partition (e.g., CU) for each block (e.g., LCU) based on the best mode (e.g., lowest cost mode) for the partition (e.g., CU).

After the decision is made as to whether a partition is going to be intra or inter coded (and the corresponding mode from the intra or inter candidates), a difference with source pixels is made via differencer 606. For example, a partition (e.g., CU) or block (e.g., LCU) of original pixel samples from input video 111 is differenced at differencer 606 with a reconstructed partition or block such that the reconstructed partition or block is generated using the corresponding best coding mode as implemented via local decode loop 614. The difference (e.g., residual partition or block) is converted to the frequency domain (e.g., using a discrete cosine transform or other transform) via transform module 609 to generate transform coefficients and the transform coefficients are quantized to generate quantized transform coefficients via quantization module 610. Such quantized transform coefficients along with various control signals (including LCU partitions and intra/inter modes data 112) are entropy encoded via entropy encoder module 613 to generate bitstream 113, which may be transmitted to a decoder or stored in memory. Furthermore, the quantized transform coefficients from quantization module 610 are inverse quantized via inverse quantization module 612 and inverse transformed via inverse transform module 612 to generate reconstructed differences or residual partitions or blocks. The reconstructed partitions or blocks are combined with reference blocks (e.g., reconstructed reference blocks as selected via selection switch 607) via adder 608 to generate reconstructed partitions or blocks, which, as shown, are provided intra prediction module 603 for use in intra prediction. Furthermore, the reconstructed differences or residuals may be deblock filtered and/or sample adaptive offset filtered via deblock filtering and sample adaptive offset module 605, reconstructed into a picture, and stored in picture buffer 604 for use in inter prediction.

As discussed, a decoupled encoder system or an integrated encoder system may implement detection indicators 419 for improved data utilization efficiency. Discussion now turns to detected features, indicators and implementation thereof.

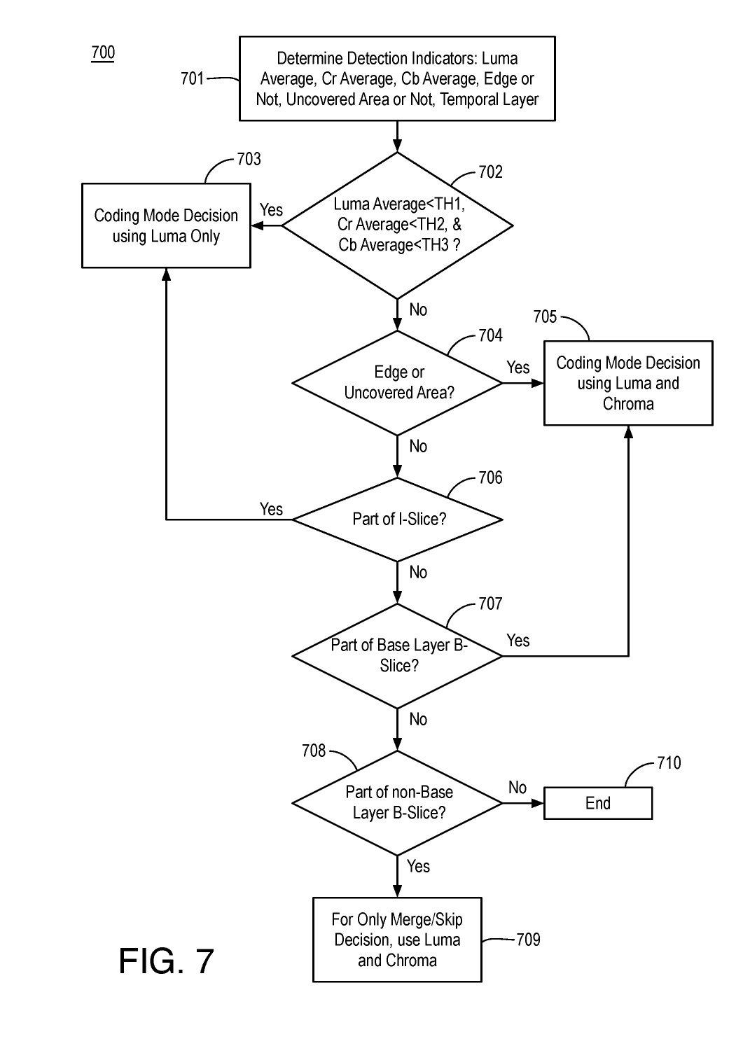

FIG. 7 is a flow diagram illustrating an example process 700 for selectively using chroma information in partitioning and coding mode decisions, arranged in accordance with at least some implementations of the present disclosure. Process 700 may include one or more operations 701-710 as illustrated in FIG. 7. Process 700 may be performed by a system (e.g., system 100, encoding system 600, etc.) to improve data utilization efficiency by selectively using chroma in partitioning and coding mode decisions in video coding. For example, using only luma information offers the advantage of faster processing and lower complexity at the cost of reduced accuracy (e.g., by eliminating chroma from cost calculations). Alternatively, using luma and chroma information offers the advantage accuracy at the cost of reduced computation speed (e.g., by adding chroma to cost calculations). Process 700 provides a trade-off between computational cost and accuracy by efficiently generating a luma and chroma or luma only evaluation decision for blocks of a picture.

Process 700 begins at decision operation 701, where, for a region, a block, or a partition of a current picture of input video, detectors are applied to generate detected features or detection indicators. For example, operation 701 may be performed by detector module 408. As shown, the detected features for a region, a block (e.g., an LCU), or a partition (e.g., CU) include a luma average of the region, block, or partition, a first chroma channel (e.g., Cb) average of the region, block, or partition, a second chroma channel (Cr) average of the region, block, or partition, an indicator of whether the region, block, or partition includes an edge, an indicator of whether the region, block, or partition is in an uncovered area or not, and a temporal layer of the region, block, or partition.

The detection indicators determined at operation 701 may be generated using any suitable technique or techniques. In an embodiment, the luma average is an average of the luma values at pixel locations of the region, block, or partition. In an embodiment, the first chroma channel average is an average of the chroma values at pixel locations of the region, block, or partition for a first chroma channel and the second chroma channel average is an average of the chroma values at pixel locations of the region, block, or partition for a second chroma channel. For example, the pixels may include a luma component and two chroma components such as Cb, Cr components, although any suitable color space may be implemented. Although discussed with respect to averages for all pixel locations, in some embodiments, some pixel values (e.g., high and low, outliers, etc.) may be discarded prior to generating the averages. An edge feature for the region, block, or partition may be detected using any suitable edge detection techniques such as Canny edge detection.

Furthermore, whether the region, block, or partition is in an uncovered area or not is intended to detect those regions, blocks, or partitions that are in areas that have been uncovered due to something moving in input video 111. For example, a person moving would reveal an uncovered area that was previously behind them. Such a determination as to whether the region, block, or partition is in an uncovered area may be made using any suitable technique or techniques. In an embodiment, a difference between a best motion estimation sum of absolute differences (SAD) and a best intra prediction SAD for the region, block, or partition is taken and if the best intra prediction SAD plus a threshold is less than the best motion estimation SAD, the region, block, or partition is indicated as being in an uncovered area. For example, the addition of a threshold or bias or the like to the best intra prediction SAD and the sum being less than the best motion estimation SAD may indicate the intra prediction SAD is much less than the best motion estimation SAD, which in turn indicates the region, block, or partition is in an uncovered area because no accurate motion estimation compensation may be found for the block. For example, the best motion estimation SAD may be the SAD corresponding to the best motion estimation mode as determined by SS motion estimation module 401 or motion estimation and compensation module 602 and the best intra prediction SAD may be the SAD corresponding to the best intra mode as determined by SS intra search module 402 or intra prediction module 603. That is, either open loop prediction (using only original pixel samples) or closed loop prediction (using reconstructed pixel samples) SAD may be used.

Processing continues at decision operation 702, where the luma average of the region, block, or partition, the first chroma channel average of the region, block, or partition, the second chroma channel average of the region, block, or partition are compared to corresponding thresholds. If each of the luma average of the region, block, or partition, the first chroma channel average of the region, block, or partition, and the second chroma channel average of the region, block, or partition do not exceed their corresponding thresholds (e.g., they compare unfavorably to the thresholds), processing continues at operation 703. Although discussed with respect to detection indicators of block averages being compared to thresholds, in other embodiments, the detection indicators include indicators as to whether or not (e.g., 1 or 0, true or false) each of the averages exceeds or meets or exceeds (e.g., compares favorably to) the corresponding threshold. In such embodiments, decision operation 702 may simply determine whether any of such indicators are false.

At operation 703, only luma information is used for partitioning and coding mode decisions for the current region, block (e.g., LCU), or partition (e.g., CU). For example, in comparing an original partition or block to a predicted partition or block (predicted using only original pixel samples or predicted using reconstructed pixels), only luma pixel values are used while chroma pixel values are discarded. That is, when distortion measurements, comparisons, etc. are made between the block or partition and a prediction block or partition, only luma information is used. Such techniques may be implemented using any suitable modules or components discussed herein that take part in partitioning and coding mode decisions for the current block such as modules 401-407 of LCU loop module 402 and/or modules 601-612 of encoder system 600. Such modules are not listed here by name for the sake of clarity of presentation That is, any operation used in partitioning and coding mode decisions may operate only on luma information (e.g., samples) while chroma information is discarded. It is noted that modules and operations pertaining to encode operations to generate bitstream 113 still operate on both luma and chroma information for the generation of bitstream 113 (e.g., both luma and chroma residuals are generated, etc.). For example, CU loop processing module 501 operates on both luma and chroma to generate quantized transform coefficients of quantized transform coefficients, control data, and parameters 513. Furthermore, in the context of encoding system 600, modules 602, 603, 606, 609, 610 operate on luma and chroma information for the generation of bitstream 113. Such modules may, therefore, use only luma in the context of partitioning and coding mode decisions while using both in the context of generating bitstream 113 as needed. For example, such modules discard chroma in the context of partitioning and coding mode decisions to save substantial computational resources and then use the chroma information as needed to apply such partitioning and coding mode decisions to generate bitstream 113. For example, it may be advantageous to discard chroma for relatively dark blocks to save computational resources.

Returning to decision operation 702, if any of the luma average of the region, block, or partition, the first chroma channel average of the region, block, or partition, of the second chroma channel average of the region, block, or partition exceed or meet their corresponding thresholds (e.g., they compare favorably to the thresholds), processing continues at decision operation 704, where a determination is made as to whether the region, block, or partition includes an edge (as determined based on the edge detection indicator of operation 701) and/or whether the region, block, or partition is in an uncovered area (as determined based on the uncovered area detection indicator of operation 701).

If either is true, processing continues at operation 705, where luma and chroma information are used for partitioning and coding mode decisions for the current region, block (e.g., LCU), or partition (e.g., CU). For example, in comparing an original partition or block to a predicted partition or block (predicted using only original pixel samples or predicted using reconstructed pixels), both luma and chroma pixel values are used. That is, when distortion measurements, comparisons, etc. are made between the partition or block and a predicted partition or block, both luma information and chroma information are used. Such techniques may be implemented using any suitable modules or components discussed herein that take part in partitioning and coding mode decisions for the current block such as modules 401-407 of LCU loop module 402 and/or modules 601-612 of encoder system 600. For example, any operation used in partitioning and coding mode decisions may operate using both luma and chroma information (e.g., samples). For example, it may be advantageous to use both luma and chroma for blocks having edges or those in uncovered areas for improved accuracy and artifact reduction.

Returning to decision operation 704, if the region, block, or partition does not include an edge nor is it in an uncovered area, processing continues at decision operation 706, where a determination is made as to whether the region, block, or partition is a part of an I-slice or an I-picture. For example, an I-slice or I-picture may be any slice or picture that is coded without reference to another picture. With reference to FIG. 2, an I-slice or I-picture may be picture 0 or a slice of picture 0 or any slice of any other picture that is coded without reference to another picture. As shown, if the region, block, or partition is a part of an I-slice or an I-picture, process 700 continues at operation 703, where only luma information is used for partitioning and coding mode decisions for the current region, block (e.g., LCU), or partition (e.g., CU) as discussed.

If the region, block, or partition is not part of an I-slice or an I-picture, process 700 continues at decision operation 707, where a determination is made as to whether the region, block, or partition is a part of a base layer B-slice or base layer B-picture. For example, a base layer B-slice or B-picture may be any slice or picture that is a part of a base layer (e.g., only references other pictures in the same base layer but does not reference non-base layer pictures). With reference to FIG. 2, a base layer B-slice or B-picture may be picture 8, 16, . . . such that the base layer B-slice or B-picture may reference I-picture 0 or other base layer B-pictures but not non-base layer B-pictures. As shown, if the region, block, or partition is a part of a base layer B-slice or base layer B-picture, process 700 continues at operation 705, where luma and chroma information are used for partitioning and coding mode decisions for the current region, block (e.g., LCU), or partition (e.g., CU) as discussed above.

If the region, block, or partition is not a part of a base layer B-slice, process 700 continues at decision operation 708, where a determination is made as to whether the region, block, or partition is a part of a non-base layer B-slice or B-picture. For example, a non-base layer B-slice or B-picture may be any slice or picture that is a part of a non-base layer (e.g., references other pictures in the base layer, the same layer, and lower layers but is not a reference for base layer pictures or lower layers). With reference to FIG. 2, a non-base layer B-slice or B-picture may be a layer L1 non-base layer picture (4, 12, . . . ), a layer L2 non-base layer picture (2, 6, 7, 14, . . . ), or a layer L3 non-base layer picture (1, 3, 5, 7, 8, 11, 13, 15, . . . ) such that the non-base layer B-slice or B-picture may reference pictures in the same or lower layers. If the region, block, or partition is not a part of a non-base layer B-slice or B-picture, processing ends at operation 710.

As shown, if the region, block, or partition is a part of a non-base layer B-slice or B-picture, process 700 continues at operation 709, where both luma and chroma information are used for merge/skip decisions only, while other partitioning and coding mode decisions are made using only the luma information and without use of the chroma plane or component. For example, in evaluating intra, inter, AMVP, and merge candidate modes for the block, only luma pixel samples or values are used (and chroma pixel samples or values are discarded). That is, when distortion measurements, comparisons, etc. are made between a partition or block and a predicted partition or block for the above modes, only luma information is used. Then, if the selected coding mode is a merge candidate mode, the decision between merge mode (using the merge MV and sending residual data) and skip mode (using the merge MV and sending no residual data) is made using the luma information and the chroma information. For example, the merge-skip decision may be performed as a last step in the partitioning and mode decision process to decide on whether a partition or block is to be coded as a merge partition or block or as a skip partition or block. Such a merge-skip decision may be made by comparing the costs of the two modes such that the costs are obtained using distortion values and coding rate estimates for each of the two modes. For the skip mode, the distortion is assumed to be zero such that no transform coefficients are to be coded (however the distortion used to determine the cost of the skip mode is not zero). For the merge mode, the distortion is a measure of the difference between the partition or block being coded and the predicted partition or block. In the context of operation 709, such a distortion measurement is generated using both luma pixel samples or values and chroma pixel samples or values.

For example, in SS motion estimation module 401, SS intra search module 402, CU fast loop processing module 403, CU full loop processing module 404, and inter-depth decision module 405, only luma pixel values are used for a block that is a part of a non-base layer B-slice or B-picture. However, in skip-merge decision module 407, both luma and chroma pixel values are used when a block is a part of a non-base layer B-slice or B-picture.

Similarly, in controller 601, motion estimation and compensation module 602, intra prediction module 603, and corresponding modules used for reconstruction, only luma pixel values are used for partitioning and coding mode decisions other than the skip-merge decision and, in controller 601, both luma and chroma pixel values are used for the skip-merge decision for a block that has been decided as a merge coded block.

The chroma incorporation techniques discussed with respect to process 700 and elsewhere herein may offer reduced processing requirements (as chroma is not used for all mode decisions) while mitigating artifacts caused by eliminating the use of chroma altogether. For example, eliminating the use of chroma information may lead to visual artifacts such as color trailing or bleeding and blockiness. The techniques discussed herein may reduce or eliminate such artifacts. The described techniques may provide for switching between different chroma processing modes that correspond to varying levels of chroma information usage. For example, such switching is based on luma and chroma levels, edge detection, uncovered area detection, and temporal layer information (e.g., base or non-base layer information) such that pictures having differing detected features make use of different amounts of chroma information. In an embodiment, the different modes are defined as full chroma, chroma for merge-skip decision only, or no chroma. For full chroma, all cost calculations used in mode decisions for partitioning and coding mode decisions use full chroma data (e.g., of 4:2:0 input video). In chroma for merge-skip decision only, chroma information is used only for the purpose of deciding between the merge mode and the skip mode such that the decision between merge mode and skip mode for a merge candidate is based on the cost associated with each candidate using full luma and chroma information. In no chroma or chroma off, as the name implies, no chroma information is used for mode decisions. In an embodiment, for I-slices or I-pictures, no chroma is used; for base-layer B-slices full chroma is used; and for non-base layer B-slices, full chroma is used for merge-skip decision only.

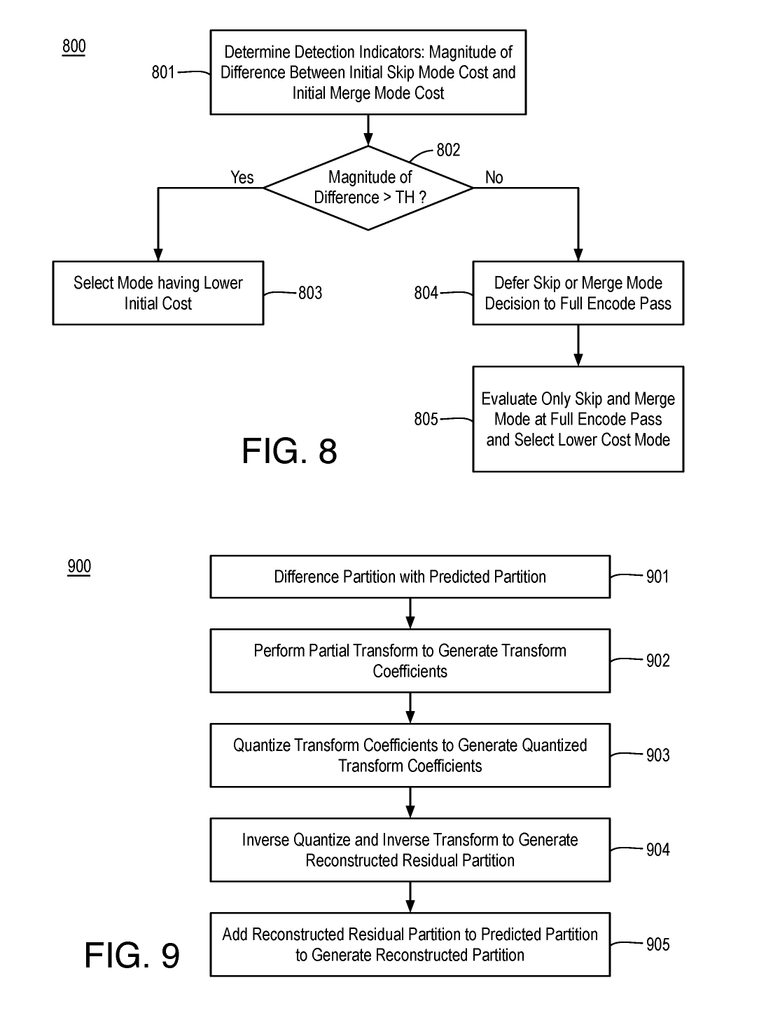

FIG. 8 is a flow diagram illustrating an example process 800 for generating a merge or skip mode decision for a partition having an initial merge mode decision, arranged in accordance with at least some implementations of the present disclosure. Process 800 may include one or more operations 801-805 as illustrated in FIG. 8. Process 800 may be performed by a system (e.g., system 100, encoding system 600, etc.) to improve data utilization efficiency by generating a merge or skip mode decision for a partition based on initial merge and skip mode coding costs. For example, using initial merge and skip mode coding costs offers the advantage of faster processing and lower complexity during encoding.

Process 800 begins at decision operation 801, where, for a block or region of a current picture of input video, detectors are applied to generate detected features or detection indicators. For example, operation 801 may be performed by detector module 408. As shown, the detected feature for a block (e.g., an LCU) or a partition of a block (e.g., a CU) include a magnitude of a difference between an initial skip mode coding cost and an initial merge mode coding cost for a partition having an initial merge mode decision. For example, in the context of a decoupled encoder, CU fast loop processing module 403 and/or CU full loop processing module 404 may determine an initial best coding mode decision for a partition (e.g., CU) is a merge mode. Such a merge mode indicates motion inference candidates using MVs from spatially neighboring partitions (e.g., CUs) of a partition (e.g., CU) are to be used for coding the partition. Both the skip and merge coding mode use the inferred MV, but the skip and merge coding modes differ in that, in the skip mode, no residual is sent for the partition while, in the merge mode, a residual is sent for the partition. In the context of an integrated encode system, controller 601, motion estimation and compensation module 602, and intra prediction module 603 may determine an initial merge mode for the partition while, again, the determination of whether to use skip or merge mode for the initial merge mode partition is delayed.

The detection indicator determined at operation 801 may be generated using any suitable technique or techniques. In an embodiment, an initial merge mode coding cost and an initial skip mode coding cost are determined for the partition using original pixel samples, approximated reconstructed pixel samples, etc. In an embodiment, the coding costs are rate distortion coding costs. As shown, processing continues at decision operation 802, where the magnitude of the difference between the initial merge mode and skip mode coding costs are compared to a threshold. As shown, if the magnitude of the difference exceeds the threshold (or meets or exceeds the threshold or compares favorably to the threshold), processing continues at operation 803, where the mode having the lower coding cost is selected for coding. Furthermore, comparison of the coding costs at full encode (e.g., as performed by CU loop processing module 501) is skipped in response to the magnitude of the difference exceeding, for example, the threshold. Such techniques offer the advantages of efficiency as full encode loop operations are reduced in such contexts.

Returning to decision operation 802, if the magnitude of the difference does not exceed the threshold (e.g., compares unfavorably to the threshold), processing continues at operation 804, where the skip or merge mode decision is deferred to a full encode pass. That is, the skip or merge mode decision is not based on the initial coding costs. Instead, processing continues at operation 805, where only the skip or merge modes are evaluated for the partition (e.g., CU) at a full encode pass and the lower cost mode is selected for encoding. For example, in the context of a decoupled encoder, the full encode pass may be performed by CU loop processing module 501. In the context of an integrated coding system, the full encode pass may be performed by controller 601 and motion estimation and compensation module 602. In any event, at the full encode pass only skip and merge modes are evaluated for the partition such that evaluation of other inter and/or intra modes is skipped. The skip or merge mode evaluation at the full encode pass may be performed using any suitable technique or techniques such as differencing the partition (e.g., CU) with a reconstructed partition (e.g., CU) reconstructed using a local decode loop based on the merge mode candidate motion vector, transforming the resultant residual, quantizing the transformed residual coefficients, and generating a skip mode cost associated with not including the resultant transformed residual coefficients in the encode and a merge mode cost associated with including the resultant transformed residual coefficients in the encode. As discussed, such a cost may be rate distortion cost including a distortion cost and a rate cost of the modes. The resultant costs may then be compared and the mode corresponding to the lower cost is selected as the final mode for the partition (e.g., CU). The partition is then encoded using the resultant final mode into bitstream 113.

The merge or skip mode selection techniques discussed with respect to process 800 and elsewhere herein may offer reduced processing requirements (as for cases where initial mode costs indicate use of one of merge or skip mode, full encode pass evaluation is skipped) while mitigating artifacts caused by eliminating the use of such full encode pass evaluation in instances where the choice of merge or skip mode is not resolved using the initial costs.

FIG. 9 is a flow diagram illustrating an example process 900 for determining a partitioning decision and coding mode decisions for a block by generating only a portion of a transform coefficient block for a partition of the block, arranged in accordance with at least some implementations of the present disclosure. Process 900 may include one or more operations 901-905 as illustrated in FIG. 9. Process 900 may be performed by a system (e.g., system 100, encoding system 600, etc.) to improve data utilization efficiency by reducing transform coefficient computations. For example, by reducing the number of available transform coefficients when performing transforms during partitioning and coding mode decisions, computations are reduced for more efficient processing.

Process 900 begins at decision operation 901, where a partition (e.g., CU or PU) is differenced with a predicted partition (e.g., CU or PU). The predicted partition may be generated using any suitable technique or techniques. For example, the predicted partition may be a candidate predicted partition corresponding to a candidate coding mode for a candidate partition (e.g., CU) of a block (e.g., LCU). The predicted partition is generated using intra or inter techniques based on the pertinent coding mode under test. In an embodiment, in the context of a decoupled decoder, the predicted partition may include a partition generated using only original pixel samples as discussed herein. In other embodiments, the predicted partition is generated using reconstructed pixel samples. In either case, the partition of the input video is differenced with the predicted partition to generate a residual partition. The predicted partition (e.g., CU or PU) may be differenced with an original partition to generate a residual partition. The residual partitions may then be further partitioned into partitions (e.g., TUs) for the purpose of transform processing. For example, the discussed differencing may be performed at the CU or PU level with subsequent transform processing being performed at the TU level.

Processing continues at operation 902, where a partial transform is performed on the residual partition (e.g., TU) to generate transform coefficients such that the number of available transform coefficients is fewer than the number of residual values in the residual partition (e.g., TU). For example, if the residual partition (e.g., TU) is an 8×8 partition, the residual partition has 64 values (although some may be zero). In such an example, the number of available transform coefficients after partial transform is fewer than 64, such as 36 (e.g., for a 6×6 transform coefficient block), 16 (e.g., for a 4×4 transform coefficient block), and so on. As with the available residual values, some of the transform coefficient values determined using the partial transform may be zero; however such values are still available in the application of the partial transform. Those transform coefficients that are not determined as part of the application of the partial transform may be set to zero. For example, the application of the partial transform may calculate some available transform coefficient values as zero and those that are unavailable are set to zero such that a resultant transform coefficient block has the same number of values as the residual partition (e.g., TU). In an embodiment, at operation 902, a transform coefficient block is generated based on a residual partition (e.g., TU) from operation 901 by performing a partial transform on the residual partition to generate transform coefficients of a portion of the transform coefficient block such that a number of transform coefficients in the portion is less than a number of values of the residual partition and setting the remaining transform coefficients of the transform coefficient block to zero.

The partial transform performed at operation 902 may be performed using any suitable technique or techniques. In an embodiment, performing the partial transform includes applying only those transform computations required to generate transform coefficients for those coefficients that are to be available after the partial transform while those transform computations needed to generate transform coefficients that are not to be available after the partial transform are skipped. The partial transform discussed herein may be characterized as a partial frequency transform, a limited transform, a limited frequency transform, a reduced frequency transform, or the like.

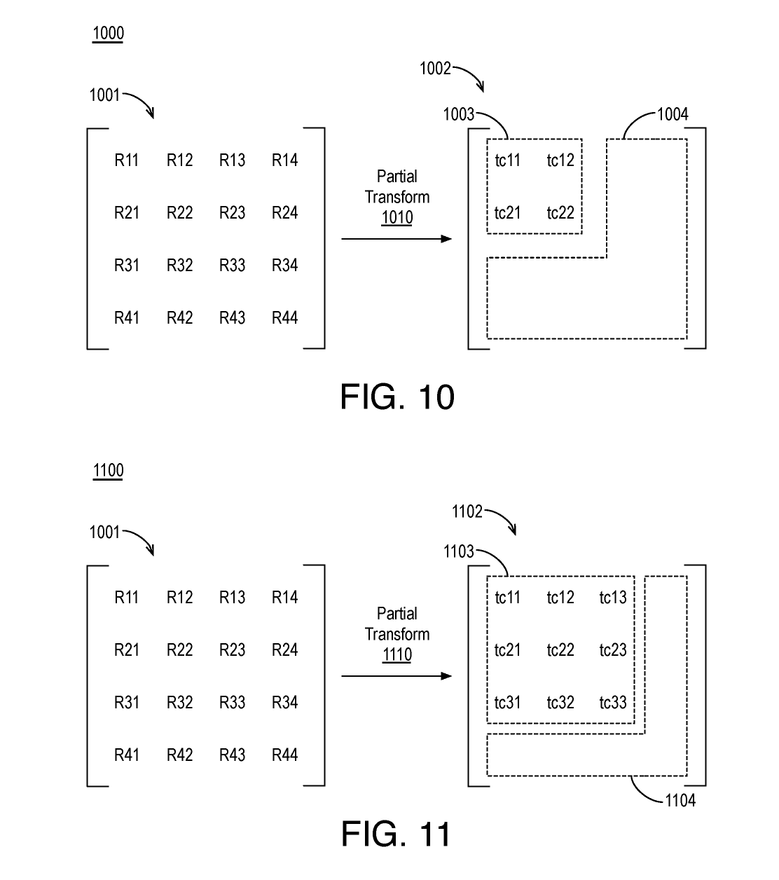

FIG. 10 illustrates an example data structure 1000 corresponding to an example partial transform 1010, arranged in accordance with at least some implementations of the present disclosure. As shown in FIG. 10, an example 4×4 residual block 1001 includes 16 available residual values (labeled R11, R12, R13, . . . R44). For example, residual block 1001 may be partition such as a TU. Although illustrated with respect to 4×4 residual block 1001, residual block 1001 may be any suitable size such as 8×8, 16×16, 32×32, etc. Also as shown in FIG. 10, partial transform 1010 transforms the residual values of residual block 1001 to the frequency domain such that the resultant transform coefficient block 1002 has fewer available transform coefficients 1003 (4 in the illustrated example, labeled tc11, tc12, tc21, tc22) than the number of available residual values of residual block 1001. In the illustrated example, residual block 1001 has 16 available residual values and transform coefficient block 1002 has 4 available transform coefficient values. However, the number of available residual values and the number of available transform coefficient values post-partial transform may be any suitable values so long as the number of available transform coefficient values is less than the number of available residual values. In an embodiment, residual block 1001 is an 8×8 block and transform coefficient block 1002 is a 4×4 block. In an embodiment, residual block 1001 is a 16×16 block and transform coefficient block 1002 is an 8×8 block. In an embodiment, residual block 1001 is a 32×32 block and transform coefficient block 1002 is a 16×16 block.

Furthermore, FIG. 10 illustrates unavailable transform coefficient values 1004, which are not available due to the application of a partial transform instead of a full transform. As shown, available transform coefficients 1003 after partial transform 1010 may be those in a top left corner of the full transform coefficients from a full transform. Such available transform coefficients 1003 retain lower frequency information in transform coefficient block 1002 while effectively discarding higher frequency information. Such techniques may provide for more accurate representations of lower frequency residual blocks. However, available transform coefficients 1003 may be any portion of the full transform coefficients from a full transform and may correspond to any frequency transform coefficients.

FIG. 11 illustrates an example data structure 1100 corresponding to another example partial transform 1110, arranged in accordance with at least some implementations of the present disclosure. As shown in FIG. 11, partial transform 1110 transforms the residual values of residual block 1001 to the frequency domain such that the resultant transform coefficient block 1102 has fewer available transform coefficients 1103 (9 in the illustrated example, labeled tc11, tc12, tc13, . . . tc33) than the number of available residual values of residual block 1001. In the illustrated example, residual block 1001 has 16 available residual values and transform coefficient block 1102 has 9 available transform coefficient values. However, the number of available residual values and the number of available transform coefficient values post-partial transform may be any suitable values so long as the number of available transform coefficient values is less than the number of available residual values. In an embodiment, residual block 1001 is an 8×8 block and transform coefficient block 1102 is a 6×6 block. In an embodiment, residual block 1001 is a 16×16 block and transform coefficient block 1102 is a 12×12 block. In an embodiment, residual block 1001 is a 32×32 block and transform coefficient block 1002 is a 16×16 block. Furthermore, FIG. 11 illustrates unavailable transform coefficient values 1104, which are not available due to the application of a partial transform instead of a full transform as discussed with respect to FIG. 10. Also, as discussed with respect to FIG. 10, available transform coefficients 1103 after partial transform 1100 may be those in a top left corner of the full transform coefficients from a full transform.

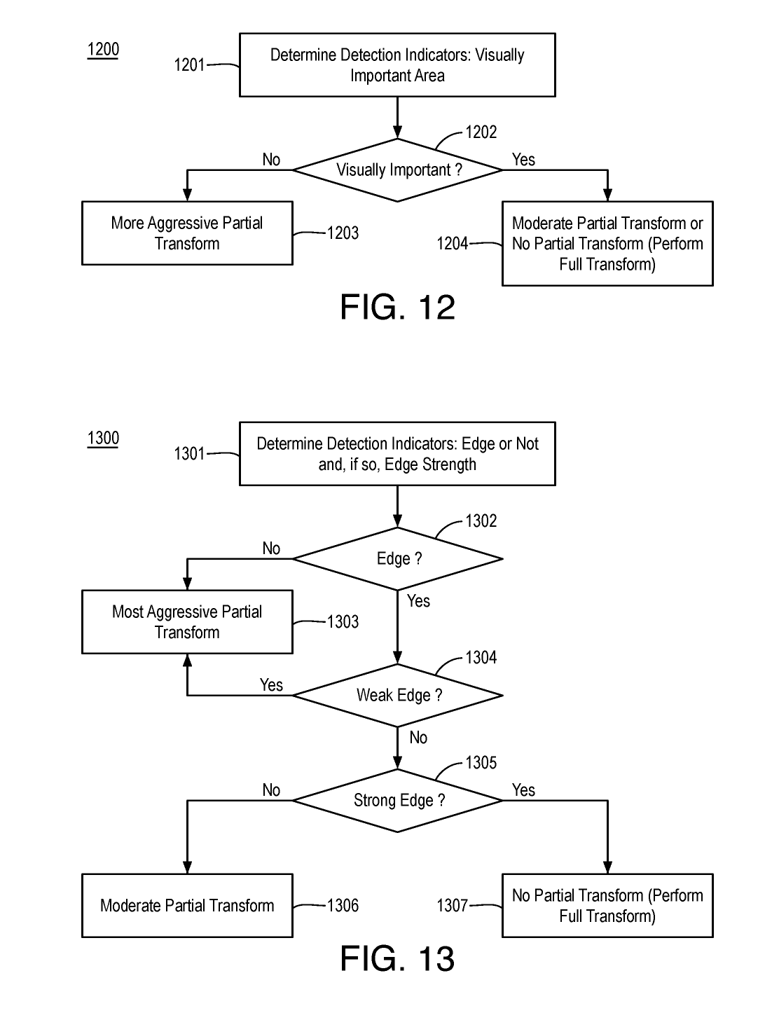

As shown with respect to FIGS. 10 and 11, the application of partial transforms 1001, 1100 may have varying levels of reduction in available transform coefficient values 1003, 1103. For example, partial transform 1001 reduces the number of available transform coefficient values 1003 to 4 while partial transform 1100 reduces the number of available transform coefficient values 1103 to 9. Due to such variation in the number of available transform coefficient values, transform coefficient block 1102 better represents residual block 1001 as compared to transform coefficient block 1002 due to transform coefficient block 1102 having more lost information. Therefore, partial transform 1010 may be described as more aggressive or more lossy as compared to partial transform 1110, which may be described as more moderate, less aggressive, or less lossy. As discussed further herein with respect to FIGS. 12 and 13, more or less aggressive partial transforms may be performed for residual partitions or blocks depending on detected features or characteristics of the blocks corresponding to the residual partitions or blocks.

Returning to FIG. 9, processing continues at operation 903, where the transform coefficients generated at operation 902 are quantized to quantized transform coefficients. The transform coefficients may be quantized using any suitable technique or techniques. The number of quantized transform coefficients is equal to the number of transform coefficients. Therefore, the number of available quantized transform coefficients is also less than the number residual values in the residual partition generated at operation 902.

Processing continues at operation 904, where the quantized transform coefficients are inverse quantized and inverse transformed to generate a reconstructed residual partition (e.g., TU). The inverse quantization and inverse transform may be performed using any suitable technique or techniques that invert the operations performed at operations 902, 903. For example, an inverse transform may be performed to generate a reconstructed residual block (e.g., TU) having the same number of available values as the number of residuals as generated at operation 901. For example, the inverse transform may account for the fact that some of the inverse quantized coefficients are zero to reduce the number of calculations, but the reconstructed residuals may be the full array of residuals. Thereby, the reconstructed residual block has the same number of values and the same block shape (e.g., size) as the residual block generated at operation 902. In an embodiment, multiple TUs may be combined to form a CU or PU.

Processing continues at operation 905, where the reconstructed residual block generated at operation 904 is added to the predicted partition (as discussed at operation 901) to generate a reconstructed partition (e.g., CU or PU) corresponding to the original partition (again discussed at operation 901). The reconstructed partition may then be used in partitioning decisions and coding mode decisions for the block that the partition is a part of. For example, process 900 may be repeated for any number of candidate coding mode options (inter and intra) and for any number of candidate partitions (e.g., candidate PUs or CUs) of a block (e.g., LCU) to select a partitioning for the block (e.g., LCU) and coding modes for partitions (e.g., CUs) corresponding to the partitioning and the best partitioning decision as well as best or coding modes several best coding modes (e.g., to be further evaluated) may be selected for the partitions (e.g., CUs).

In another embodiment, operation 904 includes only inverse quantizing the quantized transform coefficients to generate inverse quantized transform coefficients, which may also be characterized as reconstructed transform coefficients. The reconstructed transform coefficients may then be compared to the transform coefficients generated at operation 902 for the purposes of partitioning decisions and coding mode decisions. For example, distortions may be generated based on a sum of the squares of differences between the transform coefficients from operation 902 and the output of the inverse quantization (i.e., the reconstructed transform coefficients). For example, the reconstructed transform coefficients may be used in partitioning decisions and coding mode decisions for the block that the partition is a part of as discussed above. In an embodiment, a distortion measure corresponding to the predicted partition (as discussed with respect to operation 901) is generated based on the inverse quantized transform coefficients based on a sum of the squares of differences between the transform coefficients from operation 902 and the output of the inverse quantization (i.e., the reconstructed transform coefficients).

The partial transform techniques discussed with respect to process 900 may be performed for all residual blocks or only for residual blocks in certain contexts. Furthermore, the strength of the partial transform may be varied in certain contexts as discussed herein. The partial transform techniques save computation time and resources in determining partitioning decisions and selecting coding modes by reducing transform computations as well as quantization, inverse quantization, and inverse transform computations. As discussed, the partial transform techniques may be used in determining a partitioning decision and coding mode decisions for a block by generating only a portion of a transform coefficient block for a partition of the block. In some embodiments, full transforms are applied for the full encode pass to generate standards compliant quantized transform coefficients for inclusion in bitstream 113.

FIG. 12 is a flow diagram illustrating an example process 1200 for determining a partitioning decision and coding mode decisions for a block by generating only a portion of a transform coefficient block for a partition of the block based on whether the partition is in a visually important area, arranged in accordance with at least some implementations of the present disclosure. Process 1200 may include one or more operations 1201-1204 as illustrated in FIG. 12. Process 1200 may be performed by a system (e.g., system 100, encoding system 600, etc.) to improve data utilization efficiency by reducing transform coefficient computations. For example, by reducing the number of available transform coefficients when performing transforms during partitioning and coding mode decisions, computations are reduced for more efficient processing.

Process 1200 begins at operation 1301, where, for a region, block, or partition of a current picture of input video, detectors are applied to generate detected features or detection indicators. For example, operation 1201 may be performed by detector module 408. As shown, the detected features for a region, block, or partition and/or detection indicator indicate whether the region, block, or partition is or is within a visually important area.

The determination of whether the region, block, or partition is or is within a visually important area may be made using any suitable technique or techniques. In an embodiment, the determination is made based on whether the region, block, or partition includes an edge. For example, edge detection may be performed for the region, block, or partition using any suitable technique or techniques such as Canny edge detection techniques and, if an edge is detected, the region, block, or partition is indicated as being or being within a visually detected area.

In an embodiment, the determination is made based on whether the region, block, or partition is a still background area of video. Such a determination may be made by determining whether a collocated region, block, or partition, or an area including the region, block, or partition has a low distortion (e.g., as measured by sum of absolute differences, SAD) across frames (e.g., temporally across two or more successive frames). For example, if the SAD based on the difference between the current region, block, partition, or area and a collocated region, block, partition, or area (e.g., predicted using original pixel samples) is less than a threshold for one or more previous temporal pictures and the current picture, a determination is made that the region, block, partition, or area is in a still background and therefore a visually important area.

In an embodiment, the determination is made based on whether the region, block, or partition is in an aura area. Such a determination may be made by determining a motion estimation distortion (e.g., SAD based on a difference between the current region, block, or partition and a best candidate predicted ME region, block, or partition) is greater than a first threshold, the best candidate motion vector corresponding to the best candidate predicted ME has a magnitude that is greater than a second threshold, and at least one spatially adjacent region, block, or partition of the current region, block, or partition has a motion estimation distortion that is greater than a third threshold, then the current region, block, or partition is identified as an aura region, block, or partition and therefore a visually important area. For example, if the current region, block, or partition has a motion estimation distortion that is large (e.g., greater than a first threshold), a long motion vector (e.g., having a magnitude greater than a second threshold), and a neighboring region, block, or partition that also has a large motion estimation distortion (e.g., greater than the first threshold or a third threshold), the region, block, or partition is an aura region, block, or partition and indicated as visually important.

As shown, processing continues at decision operation 1202, where a determination is made as to whether the region, block, or partition is visually important or if the region, block, or partition is in a visually important area. As discussed, if the region, block, or partition includes or is in an area that includes an edge, a still background, or an aura, the region, block, or partition is indicated as being visually important. If the region, block, or partition is not visually important, processing continues at operation 1203, where a most or more aggressive partial transform is applied to partitions (e.g., TUs) of the block (e.g., LCU). For example, partitions of the block may be subjected to partial transforms and other processing discussed with respect to process 900 for partitioning decisions and coding mode decisions such that the partitions of the block are subjected to more aggressive partial transforms as compared to operation 1204. For example, as discussed with respect to FIGS. 10 and 11, more aggressive transforms may reduce the number of available transform coefficients more than those of less aggressive transforms. In an embodiment, the most aggressive partial transforms applied at operation 1203 provide a number available transform coefficients that is one-quarter the number of residual values of residual blocks. For example, for 4×4 residual blocks (partitions), the most aggressive partial transforms result in 4 transform coefficients, for 8×8 residual blocks, the most aggressive partial transforms result in 16 transform coefficients, and so on.

If the region, block, or partition is visually important, processing continues at operation 1204, where a moderate or less aggressive partial transform (as compared to that applied at operation 1203) is applied to partitions (e.g., TUs) of the block (e.g., LCU) or no partial transform is applied at all (e.g., a full transform is applied). For example, partitions of the block may be subjected to partial transforms and other processing discussed with respect to process 900 for partitioning decisions and coding mode decisions such that the partitions of the block are subjected to less aggressive partial transforms as compared to operation 1203. For example, as discussed with respect to FIGS. 10 and 11, more aggressive transforms may reduce the number of available transform coefficients more than those of less aggressive transforms. As discussed, the most aggressive partial transforms applied at operation 1203 may provide a number of available transform coefficients that is one-quarter the number of residual values of residual blocks. In contrast, the less aggressive partial transforms applied at operation 1204 may provide a number of available transform coefficients that is more than one-half of the number of residual values of residual blocks. For example, for 4×4 residual blocks, the less aggressive partial transforms may result in 9 transform coefficients, for 8×8 residual blocks, the less aggressive partial transforms may result in 36 transform coefficients, and so on.

As discussed with respect to operations 1201, 1202, if a region, block, or partition is visually important, a less aggressive partial transform (or a full transform) is applied to partitions (e.g., TUs) and, if the region, block, or partition is not visually important, a more aggressive partial transform (or a full transform) is applied to partitions (e.g., TUs) of a current block.

FIG. 13 is a flow diagram illustrating an example process 1300 for determining a partitioning decision and coding mode decisions for a block by generating only a portion of a transform coefficient block for a partition of the block based on edge detection in the block, arranged in accordance with at least some implementations of the present disclosure. Process 1300 may include one or more operations 1301-1307 as illustrated in FIG. 13. Process 1300 may be performed by a system (e.g., system 100, encoding system 600, etc.) to improve data utilization efficiency by reducing transform coefficient computations. For example, by reducing the number of available transform coefficients when performing transforms during partitioning and coding mode decisions, computations are reduced for more efficient processing.

Process 1300 begins at operation 1301, where, for a region, block, or partition of a current picture of input video, detectors are applied to generate detected features or detection indicators. For example, operation 1301 may be performed by detector module 408. As shown, the detected features for a region, block, or partition indicate whether the block includes an edge and, if so, an edge strength corresponding to the edge. The determination of whether the region, block, or partition includes an edge may be made using any suitable edge detection technique or techniques such as Canny edge detection. If the region, block, or partition does include an edge, the edge strength may be generated using any suitable technique or techniques. In an embodiment, the edge strength is a variance of the region, block, or partition. In an embodiment, the edge strength is a measure of contrast across the edge. In some embodiments, the variance or contrast measurement may be categorized via thresholding to label the edge as, for example, weak (e.g., if the variance or contrast measurement is less than a corresponding threshold), strong, (e.g., if the variance or contrast measurement is greater than a corresponding threshold), etc. For example, the edge may be categorized as strong or weak, strong, moderate, or weak, or the like.

Processing continues at decision operation 1302, where a determination is made as to whether the region, block (e.g., LCU), or partition (CU) includes an edge. If not, processing continues at operation 1303, where a most aggressive partial transform is applied to partitions (e.g., TUs) of the block (e.g., LCU). For example, partitions of the region, block, or partition may be subjected to partial transforms and other processing discussed with respect to process 900 for partitioning decisions and coding mode decisions such that the partitions of the block are subjected to more aggressive partial transforms as compared to operation 1306. For example, as discussed with respect to FIGS. 10 and 11, more aggressive transforms may reduce the number of available transform coefficients more than those of less aggressive transforms. In an embodiment, the most aggressive partial transforms applied at operation 1303 provide a number available transform coefficients that is one-quarter the number of residual values of residual blocks. For example, for 4×4 residual blocks (partitions), the most aggressive partial transforms result in 4 transform coefficients, for 8×8 residual blocks, the most aggressive partial transforms result in 16 transform coefficients, and so on.

Returning to decision operation 1302, if the region, block, or partition includes an edge, processing continues at operation 1304, where a determination is made as to whether the edge is a weak edge. If so, processing continues at operation 1303 as discussed above where most aggressive partial transforms are applied to residual partitions (e.g., TUs) of the region, block, or partition. If not, processing continues at decision operation 1305, where a determination is made as to whether the edge is a strong edge. If so, processing continues at operation 1307, where no partial transform is applied to residual partitions (e.g., TUs) of the block (e.g., LCU). That is, for blocks with a strong edge, the partitions are evaluated for partitioning decision and coding mode decisions using full transforms such that the number of available transform coefficients for the full transform equals the number residual values of the residual partitions. For example, partitions of the block may be subjected to full transforms and other processing (e.g., quantization, inverse quantization, inverse transform) for partitioning decisions and coding mode decisions.

If the region, block, or partition does not have a strong edge (e.g., the block has a medium or moderate edge), processing continues at operation 1306, where a moderate or less aggressive partial transform (as compared to that applied at operation 1303) is applied to partitions (e.g., TUs) of the block (e.g., LCU). For example, partitions of the block may be subjected to partial transforms and other processing discussed with respect to process 900 for partitioning decisions and coding mode decisions such that the partitions of the block are subjected to less aggressive partial transforms as compared to operation 1303. For example, as discussed with respect to FIGS. 10 and 11, more aggressive transforms may reduce the number of available transform coefficients more than those of less aggressive transforms. As discussed, the most aggressive partial transforms applied at operation 1303 may provide a number available transform coefficients that is one-quarter the number of residual values of residual blocks. In contrast, the less aggressive partial transforms applied at operation 1306 may provide a number available transform coefficients that is more than one-half of the number of residual values of residual blocks. For example, for 4×4 residual blocks, the less aggressive partial transforms may result in 9 transform coefficients, for 8×8 residual blocks, the less aggressive partial transforms may result in 36 transform coefficients, and so on.

As discussed, operations 1303, 1306, 1307 may include applying different levels of partial transforms in evaluating partitioning and coding mode decisions. Such partitioning and coding mode decisions evaluation may include any other characteristics discussed herein such as quantization operations, inverse quantization operations, inverse partial transform operations, comparisons of costs for various candidate partitionings, candidate coding modes, etc. The discussed partial transforms decrease computation resources and time needed for such partitioning and coding mode decisions. As will be appreciated, full transforms are applied for the full encode pass to generate standards compliant quantized transform coefficients for inclusion in bitstream 113.

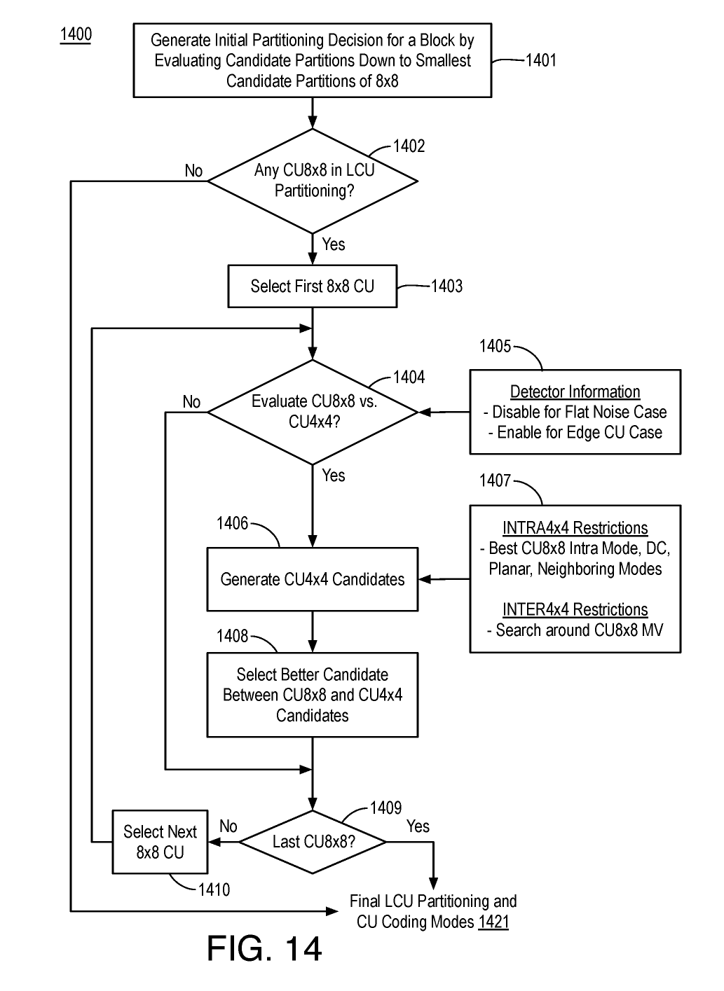

FIG. 14 is a flow diagram illustrating an example process 1400 for selectively evaluating 4×4 partitions in video coding, arranged in accordance with at least some implementations of the present disclosure. Process 1400 may include one or more operations 1401-1409 as illustrated in FIG. 14. Process 1400 may be performed by a system (e.g., system 100, encoding system 600, etc.) to improve data utilization efficiency by selectively reducing partition evaluation. For example, by reducing the number of partition evaluations in partitioning and coding mode evaluation, computations are reduced for more efficient processing. In the context of decoupled encoding systems, process 1400 may be implemented by components of LCU loop 421. In the context of integrated encoding systems, process 1400 may be implemented by controller 601, detector module 408, and intra prediction module 603.

Process 1400 begins at operation 1401, where an initial partitioning decision is made for a block by evaluating smallest candidate partitions (e.g., CUs) down to a size of 8×8 pixels (and not smaller than 8×8). For example, a block (e.g., LCU) may be partitioned into candidate partitions and the candidate partitions may be evaluated using inter and intra coding modes as discussed herein and such that the smallest available candidate partitions are 8×8 partitions. In particular, 4×4 partitions are not evaluated to save computational resources in generating the initial partitioning decision. In the context of a decoupled encoder system, operation 1401 may be performed by components of LCU loop 421 (e.g., one or more of SS motion estimation module 401, SS intra search module 402, CU fast loop processing module 403, CU full loop processing module 404, and inter-depth decision module 405). For example, operation 1401 may generate LCU partitioning data 415 and CU modes 414. In the context of integrated encoder systems, operation 1401 may be performed by controller 601, motion estimation and compensation module 602, intra prediction module 603, and components of local decode loop 614 to generate an initial partitioning decision. Furthermore, operation 1401 may generate initial coding mode decisions for the initial partitions of the block corresponding to the initial partitioning decision. In any event, operation 1401 generates an initial partitioning decision for a block (e.g., LCU) such that smallest candidate partitions down to a size of 8×8 partitions are evaluated and evaluation of smaller partitions is skipped.

Processing continues at decision operation 1402, where a determination is made as to whether any of the candidate partitions (e.g., CUs) of the initial partitioning decision of the block (e.g., LCU) are 8×8 partitions. If not, processing ends and the initial partitioning decision is used as the final partitioning decision for the block (e.g., LCU). In addition, the initial coding mode decisions for the partitions (e.g., CUs) are used as final coding mode decisions. For example, the initial partitioning decision and initial coding mode decisions may be made a final partitioning decision and final coding mode decisions to generate final LCU partitioning data and CU coding modes data 1421. For example, if the current block (e.g., LCU) does not have any 8×8 partitions (e.g., CUs) as part of the initial partitioning decision, coding modes are not evaluated for 4×4 partitions (e.g., CUs). That is, process 1400 may provide 4×4 coding mode evaluation (e.g., CU4×4) as a refinement stage only. Testing intra and/or inter coding modes for 4×4 partitions is only performed after partitioning and coding modes evaluation of a block (e.g., LCU, 64×64) to partition (e.g., CU) sizes of 8×8. If, after such processing (as discussed above), no partitions (e.g., CUs) of the block (e.g., LCU) are 8×8 in size, testing of coding modes for 4×4 size coding units is bypassed. In the discussion of FIG. 14, the terms block and partitions are used for the sake of clarity. As discussed herein, processing may be performed on any suitable LCU, CU, macroblock, etc. and partitions thereof may be termed sub-blocks, CUs, blocks, etc.

Returning to decision operation 1402, if any of the partitions (e.g., CUs) of the block (e.g., LCU) are 8×8 partitions (e.g., CUs), processing continues such that testing of intra and/or inter modes for 4×4 size coding units is evaluated. In an embodiment, such continued processing is provided for 8×8 partitions (e.g., CUs) having an inter mode or an intra mode corresponding thereto. In another embodiment, such continued processing is provided only for 8×8 partitions (e.g., CUs) having an intra mode corresponding thereto. In another embodiment, such continued processing is provided only for 8×8 partitions (e.g., CUs) having an inter mode corresponding thereto. For example, decision operation 1402 may include determining whether the current block (e.g., LCU) unit has any 8×8 intra coding mode partitions (e.g., CUs). If not, processing ends as discussed above (even if the block has an 8×8 inter coding mode coding unit). If so, processing continues with the testing of intra and/or inter modes for 4×4 size partitions (e.g., CUs).

As shown, processing continues at operation 1403, where a first 8×8 partition (e.g., CU) is selected using any suitable technique or techniques. Processing continues at optional decision operation 1404, where a determination is made as to whether the selected 8×8 partition (e.g., CUs) is to be partitioned into 4×4 partitions (e.g., CUs) and evaluated according to the results of operation 1405. As shown, at operation 1405, one or more detectors may be applied to the current block (e.g., LCU). For example, operation 1405 may be performed by detector module 408.

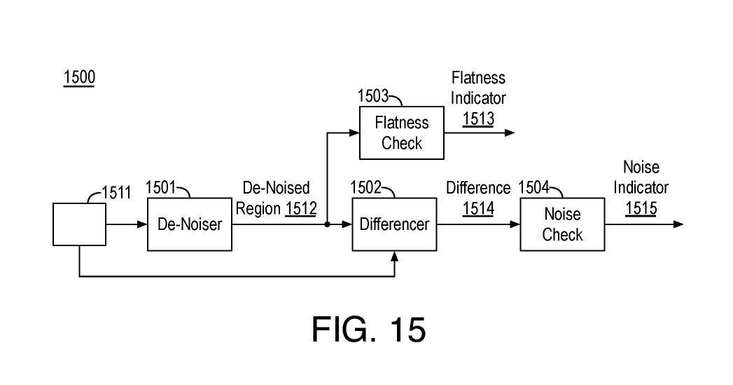

In an embodiment, a flat and noisy block (e.g., LCU) or region (e.g., a region that includes the block and other portions of the picture) detector may be applied at operation 1405 (and via detector module 408). The flat and noisy block or region detector may be applied using any suitable technique or techniques such as those discussed with respect to FIG. 15.

FIG. 15 is an illustrative diagram of an example flat and noisy region detector 1500, arranged in accordance with at least some implementations of the present disclosure. As shown in FIG. 15, flat and noisy region detector 1500 may include a de-noiser 1501, a differencer 1502, a flatness check module 1503, and a noise check module 1504. As shown, de-noiser 1501 receives an input region 1511 and de-noises input region 1511 using any suitable technique or techniques such as filtering techniques to generate a de-noised region 1512. Input region 1511 may be any suitable region such as a block (e.g., LCU), a region including the block and other blocks (e.g., LCUs) such as a region of 9×9 blocks with the target block in the middle of the region, or a slice including a block. De-noised region 1512 is provided to flatness check module 1503, which checks de-noised region 1512 for flatness using any suitable technique or techniques. In an embodiment, flatness check module 1503 determines a variance of de-noised region 1512 and compares the variance to a predetermined threshold. If the variance does not exceed the threshold, a flatness indicator 1513 is provided indicating de-noised region 1512 is flat. Furthermore, input region 1511 and de-noised region 1512 are provided to differencer 1502, which may difference input region 1511 and de-noised region 1512 using any suitable technique or techniques to generate difference 1514. As shown, difference 1514 is provided to noise check module 1504, which checks difference 1514 to determine whether input region 1511 is a noisy region using any suitable technique or techniques. In an embodiment, noise check module 1504 determines a variance of difference 1514 and compares the variance to a predetermined threshold. If the variance meets or exceeds the threshold, a noise indicator 1515 is provided indicating input region 1511 is noisy. If both flatness indicator 1513 and noise indicator 1515 are affirmed for input region 1511, input region 1511 is determined to be a flat and noisy region.

Returning to decision operation 1404 of FIG. 14, if the block is a flat noise block (or if the block is in a flat noise region), evaluation of intra and/or inter coding modes for 4×4 partitions (e.g., CUs) is bypassed such that processing may continue at decision operation 1409 as discussed below. For example, disabling 4×4 partition refinement (e.g., evaluation of coding modes for 4×4 partitions) for flat noise LCUs may offer the advantage of bypassing such evaluation when it is unlikely the 4×4 intra modes will improve visual quality with respect to the compressed video.

Returning to operation 1405, in addition or in the alternative, an edge detector may be applied to the block (e.g., LCU) or a region including the block at operation 1405. For example, edge detection may be applied by detector module 408. The edge detector may be applied using any suitable technique or techniques such as Canny edge detection techniques. In an embodiment, when an edge is detected within the current block (e.g., LCU) (or a region including the current block), evaluation of intra and/or inter coding modes for 4×4 partitions (e.g., CUs) is provided and, if not, evaluation of intra and/or inter coding modes for 4×4 partitions (e.g., CUs) is bypassed. Providing 4×4 partition refinement (e.g., evaluation of coding modes for 4×4 partitions) for blocks (e.g., LCUs) having an edge therein provides improved visual quality and reduced artifacts.

The discussed detection techniques and decisions as to whether coding modes for 4×4 partitions (e.g., CUs) are to be provided may be combined using any suitable technique or techniques. In an embodiment, all 8×8 partitions (e.g., CUs) are evaluated. In another embodiment, all 8×8 intra partitions (e.g., CUs) are evaluated (but 8×8 inter partitions (e.g., CUs) are not). In an embodiment, all 8×8 partitions (e.g., CUs) within a block (e.g., LCU) having an edge therein are evaluated. In another embodiment, only 8×8 intra partitions (e.g., CUs) within a block (e.g., LCU) having an edge therein are evaluated. In an embodiment, all 8×8 partitions (e.g., CUs) other than those that are flat and noisy are evaluated. In another embodiment, only 8×8 intra partitions (e.g., CUs) that are not flat and noisy are evaluated.

For cases where the current 8×8 partition (e.g., CU) is to be evaluated, processing continues at operation 1406, where intra and/or inter coding modes are evaluated for each of the 4×4 partitions (e.g., CUs) partitioned from the current 8×8 partition (e.g., CU) selected at operation 1403. In an embodiment, when the 8×8 partition (e.g., CU) has an initial coding mode that is an intra mode, only intra modes are evaluated at operation 1406 for the 4×4 partitions (e.g., CUs). Similarly, in an embodiment, when the 8×8 partition (e.g., CU) has an initial coding mode that is an inter mode, only inter modes are evaluated at operation 1406 for the 4×4 partitions (e.g., CUs).

In embodiments where intra modes are evaluated for the 4×4 partitions (e.g., CUs), all available intra coding modes may be evaluated or a limited set of the available intra coding modes may be evaluated. In an embodiment, the evaluated intra coding modes are limited to those as provided by optional operation 1407. As shown in operation 1407, operation 1406 may implement a restricted subset of available intra coding modes such that the subset includes only the best intra coding mode for the current 8×8 coding unit (if applicable), the DC intra mode, the planar intra mode, and one or more neighboring modes of the best intra coding mode for the current 8×8 coding unit. For example, for a particular intra directional mode, the immediate neighboring modes are those directionally adjacent to the particular intra directional mode and neighboring modes include immediate neighboring modes and a limited number of immediately adjacent modes from the immediate neighboring modes. For example, with respect to HEVC intra mode 5, immediate neighboring modes are intra modes 4 and 6 and additional neighboring modes are modes 3 and 7 (and 2 and 8, and so on). In an embodiment, the one or more neighboring modes include only the two immediate neighboring modes. In an embodiment, the one or more neighboring modes include the two immediate neighboring modes and two additional immediate neighbors of the two immediate neighboring modes (i.e., one neighbor each to the immediate neighboring modes). In an embodiment, the one or more neighboring modes include the two immediate neighboring modes and four additional immediate neighbors of the two immediate neighboring modes (i.e., two neighbors each to the immediate neighboring modes). However, and number of neighboring modes may be used.

In embodiments where inter modes are evaluated for the 4×4 partitions (e.g., CUs), a full motion estimation search may be performed or the motion estimation search may be limited to an area centered around a location indicated by the best motion vector candidate of the best inter mode for the 8×8 partition (or two areas centered around two locations if bi-prediction is the best inter mode). In an embodiment, the inter coding modes and motion estimation search are limited to those as provided by optional operation 1407. As shown in operation 1407, operation 1406 may implement a restricted subset of available inter coding modes and motion estimation search such that the subset or limitation searches only a limited area centered around a location indicated by the motion vector candidate of the best inter mode for the current 8×8 partition. As discussed, if the best inter mode for the current 8×8 partition is bi-directional prediction, two areas centered around two motion vector candidates are used. For example, for a particular inter mode motion vector, a search region for the 4×4 partitions is defined as a region of a reference picture (e.g., of original pixel samples or reconstructed pixel samples) that is centered around the location in the reference picture indicated by the motion vector of the current 8×8 partition. The search area or region centered around the location of the reference picture indicated by the motion vector of the current 8×8 partition may be limited to any search area such as a search 36×36 pixel search area centered at the location or a 100×100 pixel search area. However, any size search area (e.g., a square search area) less than an exhaustive search may be used.

As shown, processing continues from operation 1406 at operation 1408, where a better candidate between the coding mode received for the 8×8 partition (e.g., CU) and the coding modes for the four 4×4 partitions (e.g., CUs) are selected. The better coding mode candidate may be selected using any suitable technique or techniques such as rate distortion optimization techniques or the like. In the context of a decoupled encoding system, the candidate generation and selection may be made using only original pixel samples (e.g., without full decode loop reconstruction) such that either only luma samples or both luma and chroma samples are used as discussed elsewhere herein. In the context of an integrated encoding system, the candidate generation and selection may be made using reconstructed pixel samples (e.g., using local decode loop 614) such that either only luma samples or both luma and chroma samples are used as discussed elsewhere herein. If the four 4×4 partitions (e.g., CUs) are selected (each with a corresponding intra or inter coding mode), updates are made to the partitioning decision and CU coding modes decision data to generate final partitioning and coding modes 1421. For example, final partitioning and coding modes 1421 indicate 4×4 partitioning and the intra or coding mode for each of the 4×4 coding units.

Processing continues from operation 1408 at decision operation 1409, where a determination is made as to whether the current 8×8 partition (e.g., selected at operation 1403) is the last 8×8 partition (e.g., CU) in the current block (e.g., LCU). If so, processing ends and final LCU partitioning and CU coding modes 1421 are generated for the block (e.g., LCU). If not, processing continues at operation 1410, where a next 8×8 partition (e.g., CU) is selected and process 1400 continues as discussed above (beginning at decision operation 1404) until a last 8×8 partition (e.g., CU) is processed.

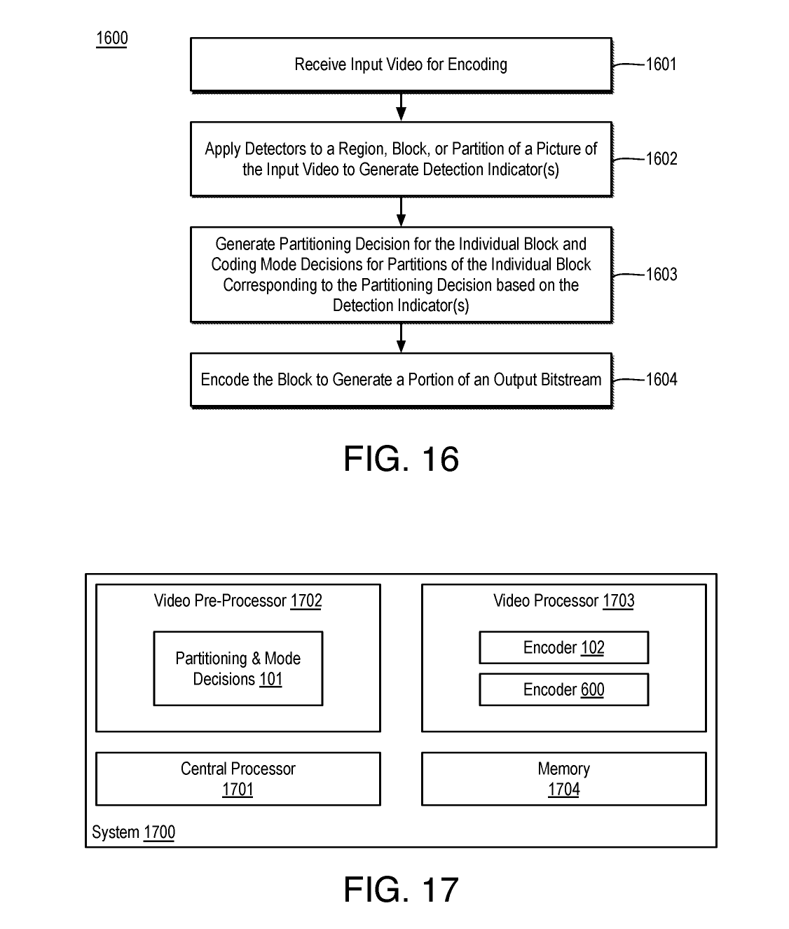

FIG. 16 is a flow diagram illustrating an example process 1600 for video encoding, arranged in accordance with at least some implementations of the present disclosure. Process 1600 may include one or more operations 1601-1604 as illustrated in FIG. 16. Process 1600 may form at least part of a video coding process. By way of non-limiting example, process 1600 may form at least part of a video coding process as performed by any device or system as discussed herein such as system 160. Furthermore, process 1600 will be described herein with reference to system 1700 of FIG. 17.

FIG. 17 is an illustrative diagram of an example system 1700 for video encoding, arranged in accordance with at least some implementations of the present disclosure. As shown in FIG. 17, system 1700 may include a central processor 1701, a video pre-processor 1702, a video processor 1703, and a memory 1704. Also as shown, video pre-processor 1702 may include or implement partitioning and mode decisions module 101 and video processor 1703 may include or implement encoder 102. In addition or in the alternative, video processor 1703 may include or implement encoder 600. In the example of system 1700, memory 1704 may store video data or related content such as input video data, picture data, partitioning data, modes data, and/or any other data as discussed herein.

As shown, in some embodiments, partitioning and mode decisions module 101 is implemented via video pre-processor 1702. In other embodiments, partitioning and mode decisions module 101 or portions thereof are implemented via central processor 1701 or another processing unit such as an image processor, a graphics processor, or the like. Also as shown, in some embodiments, encoder 102 is implemented via video processor 1703. In other embodiments, encoder 102 or portions thereof are implemented via central processor 1701 or another processing unit such as an image processor, a graphics processor, or the like. Furthermore, as shown, in some embodiments, encoding system 600 (labeled as encoder 600 in FIG. 17) is implemented via video processor 1703. In other embodiments, encoder 600 or portions thereof are implemented via central processor 1701 or another processing unit such as an image processor, a graphics processor, or the like.

Video pre-processor 1702 may include any number and type of video, image, or graphics processing units that may provide the operations as discussed herein. Such operations may be implemented via software or hardware or a combination thereof. For example, video pre-processor 1702 may include circuitry dedicated to manipulate pictures, picture data, or the like obtained from memory 1704. Similarly, video processor 1703 may include any number and type of video, image, or graphics processing units that may provide the operations as discussed herein. Such operations may be implemented via software or hardware or a combination thereof. For example, video processor 1703 may include circuitry dedicated to manipulate pictures, picture data, or the like obtained from memory 1704. Central processor 1701 may include any number and type of processing units or modules that may provide control and other high level functions for system 1700 and/or provide any operations as discussed herein. Memory 1704 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 1704 may be implemented by cache memory.

In an embodiment, one or more or portions of partitioning and mode decisions module 101, encoder 102, and encoder 600 are implemented via an execution unit (EU). The EU may include, for example, programmable logic or circuitry such as a logic core or cores that may provide a wide array of programmable logic functions. In an embodiment, one or more or portions of partitioning and mode decisions module 101, encoder 102, and encoder 600 are implemented via dedicated hardware such as fixed function circuitry or the like. Fixed function circuitry may include dedicated logic or circuitry and may provide a set of fixed function entry points that may map to the dedicated logic for a fixed purpose or function. In an embodiment, partitioning and mode decisions module 101 is implemented via field programmable grid array (FPGA).

Returning to discussion of FIG. 16, process 1600 may begin at operation 1601, where input video is received for encoding. For example, the input video may include a plurality of pictures such that a first picture of the plurality of pictures includes a region including an individual block such that the individual block includes a plurality of partitions. As discussed herein, the partitions may be any or a combination of coding units, prediction units, transform units, or the like.

Processing continues at operation 1602, where one or more detectors are applied to at least one of the region, the individual block, or one or more of the partitions to generate one or more detection indicators. The detection indicators may include any indicators discussed herein such as those discussed with respect to operation 1603.

Processing continues at operation 1603, where a partitioning decision is generated for the individual block and coding mode decisions are generated for partitions of the individual block corresponding to the partitioning decision using the detection indicators. As shown, the partitioning decision and coding mode decisions are based on at least one of generating a luma and chroma or luma only evaluation decision for a first partition of the partitions, generating a merge or skip mode decision for a second partition of the partitions having an initial merge mode decision, generating only a portion of a transform coefficient block for a third partition of the partitions, or evaluating 4×4 modes only for a fourth partition of the partitions that is an 8×8 initial coding partition.

In an embodiment, the detection indicators include indicators of whether a luma average of the first partition exceeds a first threshold, a first chroma channel average of the first partition exceeds a second threshold, and a second chroma channel average of the first partition exceeds a third threshold, and generating the partitioning decision and coding mode decisions includes generating the luma and chroma or luma only evaluation decision for the first partition by applying a luma only evaluation decision for the first partition when the luma average does not exceed the first threshold, the first chroma channel average does not exceed the second threshold, and the second chroma channel average does not exceed the third threshold. For example, the luma only evaluation decision limits partitioning and coding mode decisions to use of luma information only. In an embodiment, the detection indicators further include indicators of whether the first partition includes an edge and whether the first partition is in an uncovered area, and generating the partitioning decision and coding mode decisions includes generating the luma and chroma or luma only evaluation decision for the first partition by applying a luma and chroma evaluation decision for the first partition in response to any of the luma average, the first chroma channel average, or the second chroma channel average exceeding their respective thresholds, and the first partition including an edge or being in an uncovered area. For example, the luma and chroma evaluation decision provides for partitioning and coding mode decisions to use both luma and chroma information.

In an embodiment, the picture includes an I-slice including the first partition and generating the partitioning decision and coding mode decisions includes generating the luma and chroma or luma only evaluation decision for each partition of the picture by indicating use of luma only for the first partition in response to the first partition being in the I-slice. In an embodiment, the plurality of pictures include base layer pictures and non-base layer pictures such that base layer pictures are reference pictures for non-base layer pictures but non-base layer pictures are not reference pictures for base layer pictures, the picture is a base layer picture including a B-slice including the first partition, and generating the partitioning decision and coding mode decisions includes generating the luma and chroma or luma only evaluation decision for each partition of the picture by indicating use of luma and chroma for the first partition in response to the first partition being in the base layer B-slice. In another embodiment, the picture is a non-base layer picture including a B-slice including the first partition, and generating the partitioning decision and coding mode decisions includes generating the luma and chroma or luma only evaluation decision for each partition of the picture by indicating use of luma and chroma for the first partition only to select between a merge mode and a skip mode in response to the first partition being in the non-base layer B-slice and the partitions having initial merge mode decisions.

In an embodiment, the detection indicators include a determination of whether a magnitude of a difference between an initial skip mode coding cost and an initial merge mode coding cost for the second partition exceeds a threshold and generating the partitioning decision and coding mode decisions includes generating the merge or skip mode decision by selecting skip mode coding or merge mode coding for the second partition when the magnitude of the difference exceeds the threshold to generate a final skip or merge mode decision or deferring selection of skip mode coding or merge mode coding to a full encode pass merge mode or skip mode decision when the magnitude of the difference does not exceed the threshold.

In an embodiment, generating the partitioning decision and coding mode decisions includes generating the coding mode decisions by evaluating a coding mode for the third partition of the individual block by differencing the third partition with a predicted partition corresponding to the coding mode to generate a residual partition, generating a transform coefficient block based on the residual partition by performing a partial transform on the residual partition to generate transform coefficients of a portion of the transform coefficient block, such that a number of transform coefficients in the portion is less than a number of values of the residual partition and setting remaining transform coefficients of the transform coefficient block to zero, quantizing the transform coefficient block to generate quantized transform coefficients, inverse quantizing the quantized transform coefficients, and generating a distortion measure corresponding to the predicted partition based on the inverse quantized transform coefficients. For example, the third partition may be a TU. In an embodiment, the detection indicators includes an indicator of whether the region, the individual block, or the third partition is visually important and generating the partitioning decision and coding mode decisions includes generating only the portion of the transform coefficient block by generating a first transform coefficient block having a first number of available transform coefficients when the region, the individual block, or the third partition is visually important or generating a second transform coefficient block having a second number of available transform coefficients when the region, individual block, or third partition is not visually important, such that the second number is less than the first number.

In an embodiment, generating the partitioning decision includes determining an initial partitioning decision for the individual block that evaluates smallest candidate partitions of 8×8 candidate partitions of the individual block, the initial partitioning decision partitions the individual block into the fourth partition and one or more other partitions, and generating the partitioning decision further includes evaluating, in response to the fourth partition being an 8×8 partition, 4×4 sub-partitions of the fourth partition. In an embodiment, the detection indicators further include a best mode for the 8×8 fourth partition and evaluating the 4×4 sub-partitions includes evaluating only inter modes for the 4×4 sub-partitions when the best mode is an inter mode and evaluating only intra modes for the 4×4 sub-partitions when the best mode is an intra mode. In an embodiment, the detection indicators further include a selected motion vector for a best inter mode for the 8×8 fourth partition and evaluating the 4×4 sub-partitions includes performing a motion estimation search for each of the 4×4 sub-partitions using the selected motion vector to define a search center for the motion estimation searches. In an embodiment, the detection indicators further include a best intra mode corresponding to the 8×8 fourth partition and evaluating the 4×4 sub-partitions uses only the best intra mode corresponding to the 8×8 fourth partition, a DC mode, a planar mode, and one or more intra modes neighboring the best intra mode.

Processing continues at operation 1604, where the individual block is encoded based at least on the partitioning decision to generate a portion of an output bitstream. The individual block may be encoded using any suitable technique or techniques and the bitstream may be any suitable bitstream such as a standards compliant bitstream.

Process 1600 may be repeated any number of times either in series or in parallel for any number input video sequences, pictures, coding units, blocks, etc. As discussed, process 1600 may provide for improved video data utilization efficiency by limiting the information used in partitioning and coding mode decision.

Various components of the systems described herein may be implemented in software, firmware, and/or hardware and/or any combination thereof. For example, various components of the systems or devices discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

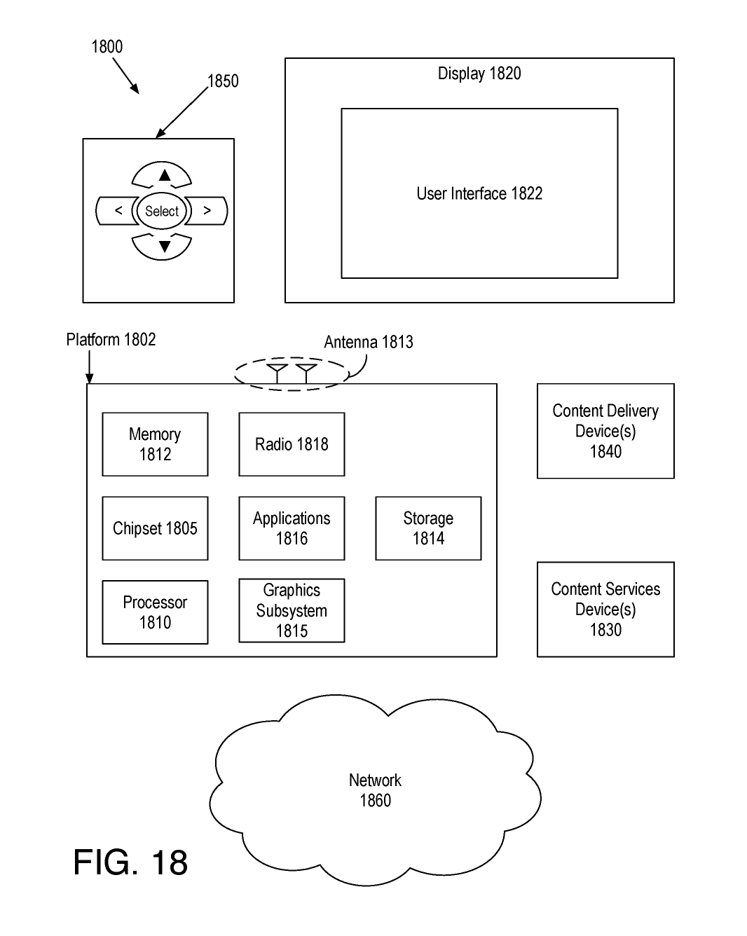

FIG. 18 is an illustrative diagram of an example system 1800, arranged in accordance with at least some implementations of the present disclosure. In various implementations, system 1800 may be a mobile system although system 1800 is not limited to this context. For example, system 1800 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1800 includes a platform 1802 coupled to a display 1820. Platform 1802 may receive content from a content device such as content services device(s) 1830 or content delivery device(s) 1840 or other similar content sources. A navigation controller 1850 including one or more navigation features may be used to interact with, for example, platform 1802 and/or display 1820. Each of these components is described in greater detail below.

In various implementations, platform 1802 may include any combination of a chipset 1805, processor 1810, memory 1812, antenna 1813, storage 1814, graphics subsystem 1815, applications 1816 and/or radio 1818. Chipset 1805 may provide intercommunication among processor 1810, memory 1812, storage 1814, graphics subsystem 1815, applications 1816 and/or radio 1818. For example, chipset 1805 may include a storage adapter (not depicted) capable of providing intercommunication with storage 1814.

Processor 1810 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1810 may be dual-core processor(s), dual-core mobile processor(s), and so forth.

Memory 1812 may be implemented as a volatile memory device such as, but not limited to, a Random Access Memory (RAM), Dynamic Random Access Memory (DRAM), or Static RAM (SRAM).

Storage 1814 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1814 may include technology to increase the storage performance enhanced protection for valuable digital media when multiple hard drives are included, for example.

Graphics subsystem 1815 may perform processing of images such as still or video for display. Graphics subsystem 1815 may be a graphics processing unit (GPU) or a visual processing unit (VPU), for example. An analog or digital interface may be used to communicatively couple graphics subsystem 1815 and display 1820. For example, the interface may be any of a High-Definition Multimedia Interface, DisplayPort, wireless HDMI, and/or wireless HD compliant techniques. Graphics subsystem 1815 may be integrated into processor 1810 or chipset 1805. In some implementations, graphics subsystem 1815 may be a stand-alone device communicatively coupled to chipset 1805.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1818 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1818 may operate in accordance with one or more applicable standards in any version.

In various implementations, display 1820 may include any television type monitor or display. Display 1820 may include, for example, a computer display screen, touch screen display, video monitor, television-like device, and/or a television. Display 1820 may be digital and/or analog. In various implementations, display 1820 may be a holographic display. Also, display 1820 may be a transparent surface that may receive a visual projection. Such projections may convey various forms of information, images, and/or objects. For example, such projections may be a visual overlay for a mobile augmented reality (MAR) application. Under the control of one or more software applications 1816, platform 1802 may display user interface 1822 on display 1820.

In various implementations, content services device(s) 1830 may be hosted by any national, international and/or independent service and thus accessible to platform 1802 via the Internet, for example. Content services device(s) 1830 may be coupled to platform 1802 and/or to display 1820. Platform 1802 and/or content services device(s) 1830 may be coupled to a network 1860 to communicate (e.g., send and/or receive) media information to and from network 1860. Content delivery device(s) 1840 also may be coupled to platform 1802 and/or to display 1820.

In various implementations, content services device(s) 1830 may include a cable television box, personal computer, network, telephone, Internet enabled devices or appliance capable of delivering digital information and/or content, and any other similar device capable of uni-directionally or bi-directionally communicating content between content providers and platform 1802 and/display 1820, via network 1860 or directly. It will be appreciated that the content may be communicated uni-directionally and/or bi-directionally to and from any one of the components in system 1800 and a content provider via network 1860. Examples of content may include any media information including, for example, video, music, medical and gaming information, and so forth.

Content services device(s) 1830 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1802 may receive control signals from navigation controller 1850 having one or more navigation features. The navigation features of may be used to interact with user interface 1822, for example. In various embodiments, navigation may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of may be replicated on a display (e.g., display 1820) by movements of a pointer, cursor, focus ring, or other visual indicators displayed on the display. For example, under the control of software applications 1816, the navigation features located on navigation may be mapped to virtual navigation features displayed on user interface 1822, for example. In various embodiments, may not be a separate component but may be integrated into platform 1802 and/or display 1820. The present disclosure, however, is not limited to the elements or in the context shown or described herein.

In various implementations, drivers (not shown) may include technology to enable users to instantly turn on and off platform 1802 like a television with the touch of a button after initial boot-up, when enabled, for example. Program logic may allow platform 1802 to stream content to media adaptors or other content services device(s) 1830 or content delivery device(s) 1840 even when the platform is turned “off.” In addition, chipset 1805 may include hardware and/or software support for 5.1 surround sound audio and/or high definition 7.1 surround sound audio, for example. Drivers may include a graphics driver for integrated graphics platforms. In various embodiments, the graphics driver may include a peripheral component interconnect (PCI) Express graphics card.

In various implementations, any one or more of the components shown in system 1800 may be integrated. For example, platform 1802 and content services device(s) 1830 may be integrated, or platform 1802 and content delivery device(s) 1840 may be integrated, or platform 1802, content services device(s) 1830, and content delivery device(s) 1840 may be integrated, for example. In various embodiments, platform 1802 and display 1820 may be an integrated unit. Display 1820 and content service device(s) 1830 may be integrated, or display 1820 and content delivery device(s) 1840 may be integrated, for example. These examples are not meant to limit the present disclosure.

In various embodiments, system 1800 may be implemented as a wireless system, a wired system, or a combination of both. When implemented as a wireless system, system 1800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1800 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1802 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 18.

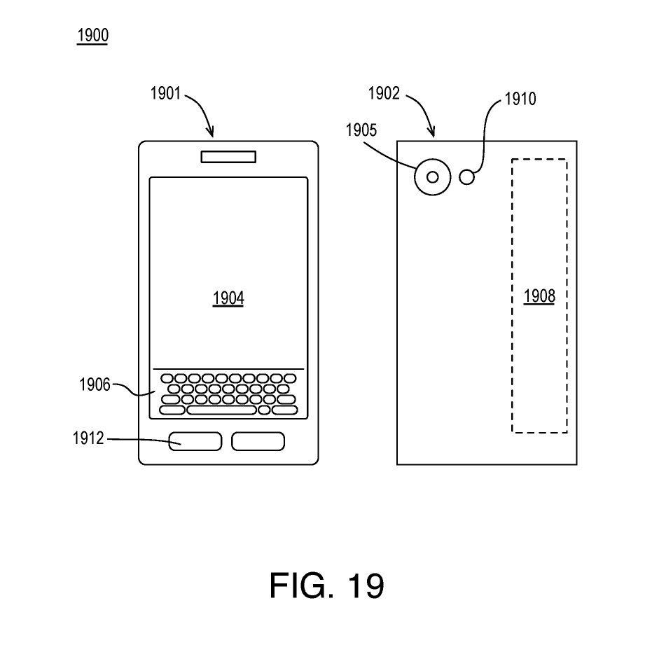

As described above, system 1800 may be embodied in varying physical styles or form factors. FIG. 19 illustrates an example small form factor device 1900, arranged in accordance with at least some implementations of the present disclosure. In some examples, system 1800 may be implemented via device 1900. In other examples, system 100 or portions thereof may be implemented via device 1900. In various embodiments, for example, device 1900 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as wrist computers, finger computers, ring computers, eyeglass computers, belt-clip computers, arm-band computers, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 19, device 1900 may include a housing with a front 1901 and a back 1902. Device 1900 includes a display 1904, an input/output (I/O) device 1906, and an integrated antenna 1908. Device 1900 also may include navigation features 1912. I/O device 1906 may include any suitable I/O device for entering information into a mobile computing device. Examples for I/O device 1906 may include an alphanumeric keyboard, a numeric keypad, a touch pad, input keys, buttons, switches, microphones, speakers, voice recognition device and software, and so forth. Information also may be entered into device 1900 by way of microphone (not shown), or may be digitized by a voice recognition device. As shown, device 1900 may include a camera 1905 (e.g., including a lens, an aperture, and an imaging sensor) and a flash 1910 integrated into back 1902 (or elsewhere) of device 1900. In other examples, camera 1905 and flash 1910 may be integrated into front 1901 of device 1900 or both front and back cameras may be provided. Camera 1905 and flash 1910 may be components of a camera module to originate image data processed into streaming video that is output to display 1904 and/or communicated remotely from device 1900 via antenna 1908 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following embodiments pertain to further embodiments.

In one or more first embodiments, a computer-implemented method for video encoding includes receiving input video for encoding, the input video including a plurality of pictures, a first picture of the plurality of pictures including a region including an individual block, such that the individual block includes a plurality of partitions, applying one or more detectors to at least one of the region, the individual block, or one or more of the plurality of partitions to generate one or more detection indicators, generating a partitioning decision for the individual block and coding mode decisions for partitions of the individual block corresponding to the partitioning decision using the detection indicators based on at least one of generating a luma and chroma or luma only evaluation decision for a first partition of the partitions, generating a merge or skip mode decision for a second partition of the partitions having an initial merge mode decision, generating only a portion of a transform coefficient block for a third partition of the partitions, or evaluating 4×4 modes only for a fourth partition of the partitions that is an 8×8 initial coding partition, and encoding the individual block based at least on the partitioning decision to generate a portion of an output bitstream.

In one or more second embodiments, for any of the first embodiments, the detection indicators include indicators of whether a luma average of the first partition exceeds a first threshold, a first chroma channel average of the first partition exceeds a second threshold, and a second chroma channel average of the first partition exceeds a third threshold, and generating the partitioning decision and coding mode decisions includes generating the luma and chroma or luma only evaluation decision for the first partition by applying a luma only evaluation decision for the first partition when the luma average does not exceed the first threshold, the first chroma channel average does not exceed the second threshold, and the second chroma channel average does not exceed the third threshold.

In one or more third embodiments, for any of the first or second embodiments, the detection indicators include indicators of whether a luma average of the first partition exceeds a first threshold, a first chroma channel average of the first partition exceeds a second threshold, a second chroma channel average of the first partition exceeds a third threshold, the first partition includes an edge, and the first partition is in an uncovered area, and generating the partitioning decision and coding mode decisions includes generating the luma and chroma or luma only evaluation decision for the first partition by applying a luma and chroma evaluation decision for the first partition in response to any of the luma average, the first chroma channel average, or the second chroma channel average exceeding their respective thresholds, and the first partition including an edge or being in an uncovered area.

In one or more fourth embodiments, for any of the first through third embodiments, the picture includes an I-slice including the first partition and generating the partitioning decision and coding mode decisions includes generating the luma and chroma or luma only evaluation decision for each partition of the picture by indicating use of luma only for the first partition in response to the first partition being in the I-slice.

In one or more fifth embodiments, for any of the first through fourth embodiments, the plurality of pictures include base layer pictures and non-base layer pictures such that base layer pictures are reference pictures for non-base layer pictures but non-base layer pictures are not reference pictures for base layer pictures, the picture is a base layer picture including a B-slice including the first partition, and generating the partitioning decision and coding mode decisions includes generating the luma and chroma or luma only evaluation decision for each partition of the picture by indicating use of luma and chroma for the first partition in response to the first partition being in the base layer B-slice.

In one or more sixth embodiments, for any of the first through fifth embodiments, the plurality of pictures include base layer pictures and non-base layer pictures such that base layer pictures are reference pictures for non-base layer pictures but non-base layer pictures are not reference pictures for base layer pictures, the picture is a non-base layer picture including a B-slice including the first partition, and generating the partitioning decision and coding mode decisions includes generating the luma and chroma or luma only evaluation decision for each partition of the picture by indicating use of luma and chroma for the first partition only to select between a merge mode and a skip mode in response to the first partition being in the non-base layer B-slice and the partitions having initial merge mode decisions.

In one or more seventh embodiments, for any of the first through sixth embodiments, the detection indicators include a determination of whether a magnitude of a difference between an initial skip mode coding cost and an initial merge mode coding cost for the second partition exceeds a threshold and generating the partitioning decision and coding mode decisions includes generating the merge or skip mode decision by selecting skip mode coding or merge mode coding for the second partition when the magnitude of the difference exceeds the threshold to generate a final skip or merge mode decision or deferring selection of skip mode coding or merge mode coding to a full encode pass merge mode or skip mode decision when the magnitude of the difference does not exceed the threshold.

In one or more eighth embodiments, for any of the first through seventh embodiments, generating the partitioning decision and coding mode decisions includes generating the coding mode decisions by evaluating a coding mode for the third partition of the individual block by differencing the third partition with a predicted partition corresponding to the coding mode to generate a residual partition, generating a transform coefficient block based on the residual partition by performing a partial transform on the residual partition to generate transform coefficients of a portion of the transform coefficient block, such that a number of transform coefficients in the portion is less than a number of values of the residual partition and setting remaining transform coefficients of the transform coefficient block to zero, quantizing the transform coefficient block to generate quantized transform coefficients, inverse quantizing the quantized transform coefficients, and generating a distortion measure corresponding to the predicted partition based on the inverse quantized transform coefficients.

In one or more ninth embodiments, for any of the first through eighth embodiments, the detection indicators include an indicator of whether the region, the individual block, or the third partition is visually important and generating the partitioning decision and coding mode decisions includes generating only the portion of the transform coefficient block by generating a first transform coefficient block having a first number of available transform coefficients when the region, the individual block, or the third partition is visually important or generating a second transform coefficient block having a second number of available transform coefficients when the region, individual block, or third partition is not visually important, such that the second number is less than the first number.

In one or more tenth embodiments, for any of the first through ninth embodiments, generating the partitioning decision includes determining an initial partitioning decision for the individual block that evaluates smallest candidate partitions of 8×8 candidate partitions of the individual block, the initial partitioning decision partitions the individual block into the fourth partition and one or more other partitions, and generating the partitioning decision further includes evaluating, in response to the fourth partition being an 8×8 partition, 4×4 sub-partitions of the fourth partition.

In one or more eleventh embodiments, for any of the first through tenth embodiments, the detection indicators include a best mode for the 8×8 fourth partition and evaluating the 4×4 sub-partitions includes evaluating only inter modes for the 4×4 sub-partitions when the best mode is an inter mode and evaluating only intra modes for the 4×4 sub-partitions when the best mode is an intra mode.

In one or more twelfth embodiments, for any of the first through eleventh embodiments, the detection indicators include a selected motion vector for a best inter mode for the 8×8 fourth partition and evaluating the 4×4 sub-partitions includes performing a motion estimation search for each of the 4×4 sub-partitions using the selected motion vector to define a search center for the motion estimation searches.

In one or more thirteenth embodiments, for any of the first through twelfth embodiments, the detection indicators include a best intra mode corresponding to the 8×8 fourth partition and evaluating the 4×4 sub-partitions uses only the best intra mode corresponding to the 8×8 fourth partition, a DC mode, a planar mode, and one or more intra modes neighboring the best intra mode.

In one or more fourteenth embodiments, a system for video encoding includes a memory to store input video for encoding, the input video including a plurality of pictures, a first picture of the plurality of pictures including a region including an individual block, such that the individual block includes a plurality of partitions and one or more processors coupled to the memory, the one or more processors to apply one or more detectors to at least one of the region, the individual block, or one or more of the plurality of partitions to generate one or more detection indicators, generate a partitioning decision for the individual block and coding mode decisions for partitions of the individual block corresponding to the partitioning decision using the detection indicators based on at least one of the one or more processors to generate a luma and chroma or luma only evaluation decision for a first partition of the partitions, to generate a merge or skip mode decision for a second partition of the partitions having an initial merge mode decision, to generate only a portion of a transform coefficient block for a third partition of the partitions, or to evaluate 4×4 modes only for a fourth partition of the partitions that is an 8×8 initial coding partition, and encode the individual block based at least on the partitioning decision to generate a portion of an output bitstream.

In one or more fifteenth embodiments, for any of the fourteenth embodiments, the detection indicators include indicators of whether a luma average of the first partition exceeds a first threshold, a first chroma channel average of the first partition exceeds a second threshold, a second chroma channel average of the first partition exceeds a third threshold, the first partition includes an edge, and the first partition is in an uncovered area, and the one or more processors generate the partitioning decision and coding mode decisions includes the one or more processors to generate the luma and chroma or luma only evaluation decision for the first partition by application of a luma only evaluation decision for the first partition when the luma average does not exceed the first threshold, the first chroma channel average does not exceed the second threshold, and the second chroma channel average does not exceed the third threshold and application of a luma and chroma evaluation decision for the first partition in response to any of the luma average, the first chroma channel average, or the second chroma channel average exceeding their respective thresholds, and the first partition including an edge or being in an uncovered area.

In one or more sixteenth embodiments, for any of the fourteenth or fifteenth embodiments, the detection indicators include a determination of whether a magnitude of a difference between an initial skip mode coding cost and an initial merge mode coding cost for the second partition exceeds a threshold and the one or more processors to generate the partitioning decision and coding mode decisions includes the one or more processors to generate the merge or skip mode decision by selection of skip mode coding or merge mode coding for the second partition when the magnitude of the difference exceeds the threshold to generate a final skip or merge mode decision or deferral of selection of skip mode coding or merge mode coding to a full encode pass merge mode or skip mode decision when the magnitude of the difference does not exceed the threshold.

In one or more seventeenth embodiments, for any of the fourteenth through sixteenth embodiments, the detection indicators include an indicator of whether the region, the individual block, or the third partition is visually important and the one or more processors to generate the partitioning decision and coding mode decisions includes the one or more processors to generate only the portion of the transform coefficient block by the one or more processors to generate a first transform coefficient block having a first number of available transform coefficients when the region, the individual block, or the third partition is visually important or the one or more processors to generate a second transform coefficient block having a second number of available transform coefficients when the region, individual block, or third partition is not visually important, such that the second number is less than the first number.

In one or more eighteenth embodiments, for any of the fourteenth through seventeenth embodiments, the one or more processors to generate the partitioning decision includes the one or more processors to determine an initial partitioning decision for the individual block that evaluates smallest candidate partitions of 8×8 candidate partitions of the individual block, the initial partitioning decision partitions the individual block into the fourth partition and one or more other partitions, and to generate the partitioning decision further includes evaluation of, in response to the fourth partition being an 8×8 partition, 4×4 sub-partitions of the fourth partition.

In one or more nineteenth embodiments, for any of the fourteenth through eighteenth embodiments, the detection indicators include a best mode for the 8×8 fourth partition and the one or more processors to evaluate the 4×4 sub-partitions includes evaluation of only inter modes for the 4×4 sub-partitions when the best mode is an inter mode and evaluation of only intra modes for the 4×4 sub-partitions when the best mode is an intra mode, such that evaluation of only inter modes includes the one or more processors to evaluate the 4×4 sub-partitions by a motion estimation search for each of the 4×4 sub-partitions using a selected motion vector for a best inter mode for the 8×8 fourth partition to define a search center for the motion estimation searches, and such that evaluation of only intra modes includes the one or more processors to evaluate the 4×4 sub-partitions using only best intra mode corresponding to the 8×8 fourth partition, a DC mode, a planar mode, and one or more intra modes neighboring the best intra mode.

In one or more twentieth embodiments, at least one machine readable medium may include a plurality of instructions that in response to being executed on a computing device, causes the computing device to perform a method according to any one of the above embodiments.

In one or more twenty-first embodiments, an apparatus may include means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. A computer-implemented method for video encoding comprising:
receiving input video for encoding, the input video comprising a plurality of pictures, a first picture of the plurality of pictures comprising a region comprising an individual block, wherein the individual block comprises a plurality of partitions;
applying one or more detectors to at least one of the region, the individual block, or one or more of the plurality of partitions to generate one or more detection indicators;
generating a partitioning decision for the individual block and coding mode decisions for partitions of the individual block corresponding to the partitioning decision using the detection indicators based on at least one of generating a luma and chroma or luma only evaluation decision for a first partition of the partitions, generating a merge or skip mode decision for a second partition of the partitions having an initial merge mode decision, generating only a portion of a transform coefficient block for a third partition of the partitions, or evaluating 4×4 modes only for a fourth partition of the partitions that is an 8×8 initial coding partition; and
encoding the individual block based at least on the partitioning decision to generate a portion of an output bitstream.

2. The method of claim 1, wherein the detection indicators comprise indicators of whether a luma average of the first partition exceeds a first threshold, a first chroma channel average of the first partition exceeds a second threshold, and a second chroma channel average of the first partition exceeds a third threshold, and generating the partitioning decision and coding mode decisions comprises generating the luma and chroma or luma only evaluation decision for the first partition by applying a luma only evaluation decision for the first partition when the luma average does not exceed the first threshold, the first chroma channel average does not exceed the second threshold, and the second chroma channel average does not exceed the third threshold.

3. The method of claim 1, wherein the detection indicators comprise indicators of whether a luma average of the first partition exceeds a first threshold, a first chroma channel average of the first partition exceeds a second threshold, a second chroma channel average of the first partition exceeds a third threshold, the first partition includes an edge, and the first partition is in an uncovered area, and generating the partitioning decision and coding mode decisions comprises generating the luma and chroma or luma only evaluation decision for the first partition by applying a luma and chroma evaluation decision for the first partition in response to any of the luma average, the first chroma channel average, or the second chroma channel average exceeding their respective thresholds, and the first partition including an edge or being in an uncovered area.

4. The method of claim 1, wherein the picture comprises an I-slice comprising the first partition and generating the partitioning decision and coding mode decisions comprises generating the luma and chroma or luma only evaluation decision for each partition of the picture by indicating use of luma only for the first partition in response to the first partition being in the I-slice.

5. The method of claim 1, wherein the plurality of pictures comprise base layer pictures and non-base layer pictures such that base layer pictures are reference pictures for non-base layer pictures but non-base layer pictures are not reference pictures for base layer pictures, the picture is a base layer picture comprising a B-slice comprising the first partition, and generating the partitioning decision and coding mode decisions comprises generating the luma and chroma or luma only evaluation decision for each partition of the picture by indicating use of luma and chroma for the first partition in response to the first partition being in the base layer B-slice.

6. The method of claim 1, wherein the plurality of pictures comprise base layer pictures and non-base layer pictures such that base layer pictures are reference pictures for non-base layer pictures but non-base layer pictures are not reference pictures for base layer pictures, the picture is a non-base layer picture comprising a B-slice comprising the first partition, and generating the partitioning decision and coding mode decisions comprises generating the luma and chroma or luma only evaluation decision for each partition of the picture by indicating use of luma and chroma for the first partition only to select between a merge mode and a skip mode in response to the first partition being in the non-base layer B-slice and the partitions having initial merge mode decisions.

7. The method of claim 1, wherein the detection indicators comprise a determination of whether a magnitude of a difference between an initial skip mode coding cost and an initial merge mode coding cost for the second partition exceeds a threshold and generating the partitioning decision and coding mode decisions comprises generating the merge or skip mode decision by selecting skip mode coding or merge mode coding for the second partition when the magnitude of the difference exceeds the threshold to generate a final skip or merge mode decision or deferring selection of skip mode coding or merge mode coding to a full encode pass merge mode or skip mode decision when the magnitude of the difference does not exceed the threshold.

8. The method of claim 1, wherein generating the partitioning decision and coding mode decisions comprises generating the coding mode decisions by evaluating a coding mode for the third partition of the individual block by:
differencing the third partition with a predicted partition corresponding to the coding mode to generate a residual partition;
generating a transform coefficient block based on the residual partition by:
performing a partial transform on the residual partition to generate transform coefficients of a portion of the transform coefficient block, wherein a number of transform coefficients in the portion is less than a number of values of the residual partition; and
setting remaining transform coefficients of the transform coefficient block to zero;
quantizing the transform coefficient block to generate quantized transform coefficients;
inverse quantizing the quantized transform coefficients; and
generating a distortion measure corresponding to the predicted partition based on the inverse quantized transform coefficients.

9. The method of claim 1, wherein the detection indicators comprise an indicator of whether the region, the individual block, or the third partition is visually important and generating the partitioning decision and coding mode decisions comprises generating only the portion of the transform coefficient block by generating a first transform coefficient block having a first number of available transform coefficients when the region, the individual block, or the third partition is visually important or generating a second transform coefficient block having a second number of available transform coefficients when the region, individual block, or third partition is not visually important, wherein the second number is less than the first number.

10. The method of claim 1, wherein generating the partitioning decision comprises determining an initial partitioning decision for the individual block that evaluates smallest candidate partitions of 8×8 candidate partitions of the individual block, the initial partitioning decision partitions the individual block into the fourth partition and one or more other partitions, and generating the partitioning decision further comprises evaluating, in response to the fourth partition being an 8×8 partition, 4×4 sub-partitions of the fourth partition.

11. The method of claim 10, wherein the detection indicators comprise a best mode for the 8×8 fourth partition and evaluating the 4×4 sub-partitions comprises evaluating only inter modes for the 4×4 sub-partitions when the best mode is an inter mode and evaluating only intra modes for the 4×4 sub-partitions when the best mode is an intra mode.

12. The method of claim 10, wherein the detection indicators comprise a selected motion vector for a best inter mode for the 8×8 fourth partition and evaluating the 4×4 sub-partitions comprises performing a motion estimation search for each of the 4×4 sub-partitions using the selected motion vector to define a search center for the motion estimation searches.

13. The method of claim 10, wherein the detection indicators comprise a best intra mode corresponding to the 8×8 fourth partition and evaluating the 4×4 sub-partitions uses only the best intra mode corresponding to the 8×8 fourth partition, a DC mode, a planar mode, and one or more intra modes neighboring the best intra mode.

14. A system for video encoding comprising:
a memory to store input video for encoding, the input video comprising a plurality of pictures, a first picture of the plurality of pictures comprising a region comprising an individual block, wherein the individual block comprises a plurality of partitions; and
one or more processors coupled to the memory, the one or more processors to:
apply one or more detectors to at least one of the region, the individual block, or one or more of the plurality of partitions to generate one or more detection indicators;
generate a partitioning decision for the individual block and coding mode decisions for partitions of the individual block corresponding to the partitioning decision using the detection indicators based on at least one of the one or more processors to generate a luma and chroma or luma only evaluation decision for a first partition of the partitions, to generate a merge or skip mode decision for a second partition of the partitions having an initial merge mode decision, to generate only a portion of a transform coefficient block for a third partition of the partitions, or to evaluate 4×4 modes only for a fourth partition of the partitions that is an 8×8 initial coding partition; and
encode the individual block based at least on the partitioning decision to generate a portion of an output bitstream.

15. The system of claim 14, wherein the detection indicators comprise indicators of whether a luma average of the first partition exceeds a first threshold, a first chroma channel average of the first partition exceeds a second threshold, a second chroma channel average of the first partition exceeds a third threshold, the first partition includes an edge, and the first partition is in an uncovered area, and the one or more processors generate the partitioning decision and coding mode decisions comprises the one or more processors to generate the luma and chroma or luma only evaluation decision for the first partition by application of a luma only evaluation decision for the first partition when the luma average does not exceed the first threshold, the first chroma channel average does not exceed the second threshold, and the second chroma channel average does not exceed the third threshold and application of a luma and chroma evaluation decision for the first partition in response to any of the luma average, the first chroma channel average, or the second chroma channel average exceeding their respective thresholds, and the first partition including an edge or being in an uncovered area.

16. The system of claim 14, wherein the detection indicators comprise a determination of whether a magnitude of a difference between an initial skip mode coding cost and an initial merge mode coding cost for the second partition exceeds a threshold and the one or more processors to generate the partitioning decision and coding mode decisions comprises the one or more processors to generate the merge or skip mode decision by selection of skip mode coding or merge mode coding for the second partition when the magnitude of the difference exceeds the threshold to generate a final skip or merge mode decision or deferral of selection of skip mode coding or merge mode coding to a full encode pass merge mode or skip mode decision when the magnitude of the difference does not exceed the threshold.

17. The system of claim 14, wherein the detection indicators comprise an indicator of whether the region, the individual block, or the third partition is visually important and the one or more processors to generate the partitioning decision and coding mode decisions comprises the one or more processors to generate only the portion of the transform coefficient block by the one or more processors to generate a first transform coefficient block having a first number of available transform coefficients when the region, the individual block, or the third partition is visually important or the one or more processors to generate a second transform coefficient block having a second number of available transform coefficients when the region, individual block, or third partition is not visually important, wherein the second number is less than the first number.

18. The system of claim 14, wherein the one or more processors to generate the partitioning decision comprises the one or more processors to determine an initial partitioning decision for the individual block that evaluates smallest candidate partitions of 8×8 candidate partitions of the individual block, the initial partitioning decision partitions the individual block into the fourth partition and one or more other partitions, and to generate the partitioning decision further comprises evaluation of, in response to the fourth partition being an 8×8 partition, 4×4 sub-partitions of the fourth partition.

19. The system of claim 18, wherein the detection indicators comprise a best mode for the 8×8 fourth partition and the one or more processors to evaluate the 4×4 sub-partitions comprises evaluation of only inter modes for the 4×4 sub-partitions when the best mode is an inter mode and evaluation of only intra modes for the 4×4 sub-partitions when the best mode is an intra mode, wherein evaluation of only inter modes comprises the one or more processors to evaluate the 4×4 sub-partitions by a motion estimation search for each of the 4×4 sub-partitions using a selected motion vector for a best inter mode for the 8×8 fourth partition to define a search center for the motion estimation searches, and wherein evaluation of only intra modes comprises the one or more processors to evaluate the 4×4 sub-partitions using only best intra mode corresponding to the 8×8 fourth partition, a DC mode, a planar mode, and one or more intra modes neighboring the best intra mode.

20. At least one machine readable medium comprising a plurality of instructions that, in response to being executed on a computing device, cause the computing device to perform video coding by:
receiving input video for encoding, the input video comprising a plurality of pictures, a first picture of the plurality of pictures comprising a region comprising an individual block, wherein the individual block comprises a plurality of partitions;
applying one or more detectors to at least one of the region, the individual block, or one or more of the plurality of partitions to generate one or more detection indicators;
generating a partitioning decision for the individual block and coding mode decisions for partitions of the individual block corresponding to the partitioning decision using the detection indicators based on at least one of generating a luma and chroma or luma only evaluation decision for a first partition of the partitions, generating a merge or skip mode decision for a second partition of the partitions having an initial merge mode decision, generating only a portion of a transform coefficient block for a third partition of the partitions, or evaluating 4×4 modes only for a fourth partition of the partitions that is an 8×8 initial coding partition; and
encoding the individual block based at least on the partitioning decision to generate a portion of an output bitstream.

21. The machine readable medium of claim 20, wherein the detection indicators comprise indicators of whether a luma average of the first partition exceeds a first threshold, a first chroma channel average of the first partition exceeds a second threshold, a second chroma channel average of the first partition exceeds a third threshold, the first partition includes an edge, and the first partition is in an uncovered area, and generating the partitioning decision and coding mode decisions comprises generating the luma and chroma or luma only evaluation decision for the first partition by applying a luma only evaluation decision for the first partition when the luma average does not exceed the first threshold, the first chroma channel average does not exceed the second threshold, and the second chroma channel average does not exceed the third threshold and applying a luma and chroma evaluation decision for the first partition in response to any of the luma average, the first chroma channel average, or the second chroma channel average exceeding their respective thresholds, and the first partition including an edge or being in an uncovered area.

22. The machine readable medium of claim 20, wherein the detection indicators comprise a determination of whether a magnitude of a difference between an initial skip mode coding cost and an initial merge mode coding cost for the second partition exceeds a threshold and generating the partitioning decision and coding mode decisions comprises generating the merge or skip mode decision by selecting skip mode coding or merge mode coding for the second partition when the magnitude of the difference exceeds the threshold to generate a final skip or merge mode decision or deferring selection of skip mode coding or merge mode coding to a full encode pass merge mode or skip mode decision when the magnitude of the difference does not exceed the threshold.

23. The machine readable medium of claim 20, wherein the detection indicators comprise an indicator of whether the region, the individual block, or the third partition is visually important and generating the partitioning decision and coding mode decisions comprises generating only the portion of the transform coefficient block by generating a first transform coefficient block having a first number of available transform coefficients when the region, the individual block, or the third partition is visually important or generating a second transform coefficient block having a second number of available transform coefficients when the region, individual block, or third partition is not visually important, wherein the second number is less than the first number.

24. The machine readable medium of claim 20, wherein generating the partitioning decision comprises determining an initial partitioning decision for the individual block that evaluates smallest candidate partitions of 8×8 candidate partitions of the individual block, the initial partitioning decision partitions the individual block into the fourth partition and one or more other partitions, and generating the partitioning decision further comprises evaluating, in response to the fourth partition being an 8×8 partition, 4×4 sub-partitions of the fourth partition.

25. The machine readable medium of claim 24, wherein the detection indicators comprise a best mode for the 8×8 fourth partition and evaluating the 4×4 sub-partitions comprises evaluating only inter modes for the 4×4 sub-partitions when the best mode is an inter mode and evaluating only intra modes for the 4×4 sub-partitions when the best mode is an intra mode, wherein evaluating only inter modes comprises evaluating the 4×4 sub-partitions by performing a motion estimation search for each of the 4×4 sub-partitions using a selected motion vector for a best inter mode for the 8×8 fourth partition to define a search center for the motion estimation searches, and wherein evaluating only intra modes comprises evaluating the 4×4 sub-partitions using only best intra mode corresponding to the 8×8 fourth partition, a DC mode, a planar mode, and one or more intra modes neighboring the best intra mode.
